(19) United States
(12) Patent Application Publication
(10) Pub. No.: US 2026/0340031 A1
(43) Pub. Date: Oct. 29, 2026

(54) SYSTEMS, METHODS, AND COMPUTER-READABLE MEDIA FOR AUTOMATED INSPECTION OF BUILDING FAÇADE DEFECTS

(71) Applicant: Hong Kong Centre for Logistics Robotics Limited, Hong Kong (CN)

(72) Inventors: Benmei CHEN, Hong Kong (CN); Jihan ZHANG, Hong Kong (CN); Benyun ZHAO, Hong Kong (CN); Xi CHEN, Hong Kong (CN); Guidong YANG, Hong Kong (CN)

(21) Appl. No.: 19/176,211

(22) Filed: Apr. 11, 2025

(51) Int. Cl. G06F 16/587; B64U 10/13; B64U 101/30; G01N 21/88; G06T 3/4038; G06T 7/33

(52) U.S. Cl. CPC G06F 16/587; B64U 10/13; G01N 21/88; G06T 3/4038; G06T 7/33; B64U 2101/30; G06T 2200/08; G06T 2207/10016; G06T 2207/30108

(57) ABSTRACT

In some embodiments, provided is systems, methods and computer-readable media for automated inspection of a defect of a façade of a building. In some embodiments, the system comprises an image processing module, a digital twin module. Other example embodiments are described herein. In certain embodiments, the systems, methods and computer-readable media provide automated and efficient process the collected images to generate defect information and visualize it with the building model on the web platform, and the interface is user-friendly.

### FIELD OF INVENTION

This invention relates to automated building inspection technologies, in particular to systems, methods and computer-readable media of automated inspection of building façade defects.

### BACKGROUND OF INVENTION

The automated building façade defect inspection (including detection and registration) technology is to solve the problem that the traditional building façade inspection method is high-cost in time and manpower, and the document-based management is inefficient to deal with the mass of data in these tasks. Some existing methods build a high-fidelity model and mark the defect on the model directly, which is inefficient for automated workflow of detection and registration and unfriendly to the lifecycle management support.

### SUMMARY OF INVENTION

In the light of the foregoing background, alternative solutions of AI and digital twin based automated building façade detect detection and registration thereof are provided.

Accordingly, an exemplary embodiment of the present invention provides a system for automated inspection of a defect of a façade of a building, comprising: an image processing module that processes at least one input image of at least a portion of the façade of the building obtained from an imaging device, wherein the image processing module comprises an AI model that is configured to analyze the at least one input image to identify at least one identified defect segment in at least one identified defect image; and a digital twin module that comprises a geo-reference submodule; a registration submodule; and a visualization submodule, which are connected with each other, wherein the geo-reference submodule is configured to geo-reference a 3D model of the building to obtain a geo-referenced 3D model, wherein the registration submodule is configured to register the at least one identified defect image and the at least one identified defect segment to the geo-referenced 3D model to obtain at least one registered defect image and at least one registered defect segment, and wherein the visualization submodule is configured to visualize the at least one registered defect image, at least one the registered defect segment and the geo-referenced 3D model such that the defect of the façade of the building is automatedly inspected through the at least one visualized registered defect segment, the at least one visualized registered defect image, and the visualized geo-referenced 3D model.

Another exemplary embodiment of the present invention provides a method of automated inspection of a defect of a façade of a building using a system of claim 1, the method comprising the steps of: (a) processing, by an image processing module, at least one input image of at least a portion of the façade of the building obtained from an imaging device; wherein the step (a) further comprises the step of: (a1) analyzing, by an AI model, the at least one input image to identify at least one identified defect segment in at least one identified defect image; (b) geo-referencing, by a geo-reference submodule, a 3D model of the building to obtain a geo-referenced 3D model; (c) registering, by a registration submodule, the at least one identified defect image and the at least one identified defect segment to the geo-referenced 3D model to obtain at least one registered defect image and at least one registered defect segment; and (d) visualizing, by a visualization submodule, the at least one registered defect image, the at least one registered defect segment, and the geo-referenced 3D model such that the defect of the façade of the building is automatedly inspected through the at least one visualized registered defect segment, the at least one visualized registered defect image, and the visualized geo-referenced 3D model.

Another exemplary embodiment of the present invention provides a non-transitory computer-readable medium storing at least one computer program for implementing a method of automated inspection of a defect of a façade of a building of claim 10, the computer-readable medium comprising: (a) program instructions for processing, by an image processing module, at least one input image of at least a portion of the façade of the building obtained from an imaging device, wherein program instructions (a) further comprise: (a1) program instructions for analyzing, by an AI model, the at least one input image to identify at least one identified defect segment in the at least one identified defect image; (b) program instructions for geo-referencing, by a geo-reference submodule, a 3D model of the building to obtain a geo-referenced 3D model; (c) program instructions for registering, by a registration submodule, the at least one identified defect image and the at least one identified defect segment to the geo-referenced 3D model to obtain at least one registered defect image and at least one registered defect segment; and (d) program instructions for visualizing, by a visualization submodule, the at least one registered defect image, the at least one registered defect segment, and the geo-referenced 3D model such that the defect of the façade of the building is automatedly inspected through the at least one visualized registered defect segment, the at least one visualized registered defect image, and the visualized geo-referenced 3D model.

The above example embodiments have many benefits and advantages. In some embodiments, provided systems, methods and computer-readable media provide alternative solutions for automatic defect detection AI algorithms which includes the neural network, data processing method and the corresponding dataset; automatic GIS-based defect registration methods which include the defect localization and the coordinate transformation from the defect image to the building model; and a web-based digital twin platform for the defect and model management which includes the 2D image and 3D model data fusion, as well as the interaction design with the users.

In some embodiments, provided systems, methods and computer-readable media automatically process the collected images to generate defect information and visualize it with the building model on the web platform. In some embodiments, provided systems, methods and computer-readable media enable the maintenance practitioners easily locate the defects, access their information, make decisions and carry out further building maintenance work.

In some embodiments, the advantages of provided systems, methods and computer-readable media include but not limited to:
A. More friendly to the users with clear 2D images;
B. Easier to get access to the data with the web-based interface;
C. More efficient with the automated workflow;
D. More intelligent with the AI algorithm detection; and/or
E. More professional with digital twin driven lifecycle management support.

Certain embodiments of provided systems, methods and computer-readable media fill the gap between the manual detection and automatic detection for building maintenance, which will bring great benefits to the old residential areas, fulfilling a lot of government and private demands.

### BRIEF DESCRIPTION OF FIGURES

Through the following detailed description with reference to the accompanying drawings, the above and other features, advantages and aspects of embodiments of the present invention will become more apparent. In the drawings, identical or similar reference signs represent identical or similar elements, wherein:

FIG. 1 is a block diagram of an example system for automated detection and registration of building façade defects, according to an example embodiment.

FIG. 2A is an illustration of an example method of collecting images of a building façade by unmanned equipment, according to an example embodiment.

FIG. 2B is another illustration of an example method of collecting images of a building façade, according to the example embodiment in FIG. 2A.

FIG. 3 is a schematic workflow diagram depicting the sequence of steps executed by the training submodule for image annotation, according to an example embodiment.

FIG. 4 is a schematic workflow diagram depicting the steps executed by the training submodule for AI model training and deployment, according to an example embodiment.

FIG. 5 is an illustration of a histogram showing the number of parameters of experimented AI models for complexity comparison, according to an example embodiment.

FIG. 6 is an illustration of the defect identification results of the AI model, according to an example embodiment.

FIG. 7 is a schematic workflow diagram depicting the steps executed by the digital twin module, according to an example embodiment.

FIG. 8 is an illustration of an example geo-referenced 3D model in geographic reference map, according to an example embodiment.

FIG. 9A is a perspective view of an example two-level registration method of an identified defect segment and corresponding identified defect image to the geo-referenced 3D model, according to an example embodiment.

FIG. 9B is a front view of the example two-level registration method of an identified defect segment and corresponding identified defect image to the geo-referenced 3D model, according to an example embodiment in FIG. 9A.

FIG. 9C is an illustration of the example registration method of a defect segment to the geo-referenced 3D model, according to an example embodiment in FIG. 9A.

FIG. 10A is an illustration of an example defect 2D information visualization result of the visualization submodule, according to an example embodiment.

FIG. 10B is an illustration of an example defect 3D information visualization result of the visualization submodule, according to an example embodiment.

FIG. 11 is an illustration of example defects overall visualization results of the visualization submodule integratedly visualizing registered defect image, registered defect segment and geo-referenced 3D model of the building, according to an example embodiment.

FIG. 12 is a schematic diagram showing an example method for automated inspection of a defect of a façade of a building, according to an example embodiment.

### DETAILED DESCRIPTION

### Definitions

As used herein and in the claims, the terms “comprising” (or any related form such as “comprise” and “comprises”), “including” (or any related forms such as “include” or “includes”), “containing” (or any related forms such as “contain” or “contains”), means including the following elements but not excluding others. It shall be understood that for every embodiment in which the term “comprising” (or any related form such as “comprise” and “comprises”), “including” (or any related forms such as “include” or “includes”), or “containing” (or any related forms such as “contain” or “contains”) is used, this disclosure/application also includes alternate embodiments where the term “comprising,” “including,” or “containing” is replaced with “consisting essentially of” or “consisting of.” These alternate embodiments that use “consisting of” or “consisting essentially of” are understood to be narrower embodiments of the “comprising”, “including,” or “containing” embodiments.

As used herein and in the claims, the singular forms “a,” “an,” and “the” are intended to include the plural forms as well unless the context clearly indicates otherwise. Where a range is referred to in the specification and the claims, the range is understood to include each discrete point within the range. For example, 1-7 means 1, 2, 3, 4, 5, 6, and 7. Another example is that (a)-(d) means (a), (b), (c), and (d).

As used herein and in the claims, the term “about” is understood as within a range of normal tolerance in the art and not more than ±10% of a stated value. By way of example only, about 50 means from 45 to 55, including all values in between. As used herein, the phrase “about” a specific value also includes the specific value, for example, “about 50” includes 50.

As used herein and in the claims, the terms “general” or “generally”, or “substantial” or “substantially” mean that the recited characteristic, shape, state, structure, or value need not be achieved exactly, but that deviations or variations, including for example, tolerances, measurement error, measurement accuracy limitations and other factors known to those of skill in the art, may occur in amounts that do not preclude the effect the characteristic was intended to provide. For example, an object that has a “generally” cylindrical shape would mean that the object has either an exact cylindrical shape or a nearly exact cylindrical shape.

As used herein and in the claims, “couple” or “connect” refers to electrical coupling or connection either directly or indirectly via one or more electrical means unless otherwise stated. For example, physical electrical connection with which components are linked via wires, circuits, conductors, or PCB traces to allow the flow of electrical current or signals. For example, connection is a logical or data connection with which memories, devices or systems establish a communication link through software programs, interfaces, buses, or network protocols (e.g., USB, PCIe, or Ethernet). For example, connection is a power or signal transmission that may enable power supply and/or data exchange.

As used herein and in the claims, the terms “building” refers to any constructed or assembled physical structure, typically characterized by a defined enclosure or framework, intended for a variety of user such as human, functional, or environmental purposes. In some embodiments, buildings include, but are not limited to, shelters, enclosures, facilities, or installations that can serve as spaces for habitation, work, storage, or activity. In some embodiments, buildings may be permanent, temporary, or mobile, and can range from simple shelters to complex, multi-functional structures.

As used herein and in the claims, the terms “inspection” (or any related forms such as “inspecting,” “inspected,” or “inspects”) refers to a process or act of evaluating the condition of the object under examination including the procedures of detecting, classifying, locating, registering and/or visualizing the defects of the object with digital and/or non-digital methods.

As used herein and in the claims, the terms “identify” (or any related forms such as “identifying,” “identified,” or “identification”) refers to the process of detecting, classifying and/or localizing a target based on extracted features from input data. In some examples, identification involves analyzing data patterns, applying computational models, and determining whether an object, event, or anomaly matches predefined criteria. In some examples, identification confirms the presence of a target. In some examples, it assigns the target to a specific category. In some examples, it determines the target's position or spatial coordinates within a given environment.

As used herein and in the claims, the term “façade” refers to the exterior surface or outer structural envelope of a building, including walls, cladding, windows, doors, balconies, and/or decorative architectural elements. In some examples, “façade” is used interchangeably with “exterior walls” herein and in the claims.

As used herein and in the claims, the term “defect” refers to structural or material irregularity, deterioration, or damage on a building façade that may compromise its integrity, aesthetics, or functionality. For example, defects include cracks, spalling (surface material detachment), moisture (liquid infiltration), corrosion, deformation, discoloration, and/or delamination.

As used herein and in the claims, the term “image” refers to a digital image having a plurality of pixels arranged in a two-dimensional array with a certain height and width.

As used herein and in the claims, the term “image processing” refers to the process of manipulating and analyzing digital images to enhance, transform, or extract useful information. In some embodiments, digital processing involves applying algorithms to perform tasks such as filtering, noise reduction, image enhancement, feature extraction, and object recognition to prepare images for analysis, detect patterns or anomalies, and extract meaningful data for decision-making.

As used herein and in the claims, the term “AI” refers to Artificial Intelligence, a technique of computer science focused on creating systems or machines that can perform tasks that typically require human intelligence. In some embodiments, these tasks include learning, reasoning, problem-solving, perception, and language understanding. In some embodiments, AI systems are often powered by algorithms, machine learning, and neural networks, allowing them to perform the above tasks based on data, recognize patterns, and make decisions without explicit programming for each task. As used herein and in the claims, “AI” is used interchangeably with “machine learning,” “deep learning,” “neural network,” “deep neural network,” or “neural.”

As used herein and in the claims, the term “AI model” refers to a computational framework designed to perform specific tasks such as recognizing patterns, making predictions, or classifying data by learning from large datasets. In some embodiments, an AI model typically comprises these main components: Backbone - - - The architecture that processes input data and extracts features, often implemented using deep neural networks (e.g., Convolutional Neural Networks for image processing or Recurrent Neural Networks for sequential data); Layers/Neurons - - - Layers of interconnected nodes or neurons that adjust based on the data to recognize patterns, with each layer performing a specific function (e.g., convolution, activation, pooling); Prediction Head/Heads - - - The output layer or structure that generates predictions or classifications from the processed data, depending on the model's task (e.g., classification labels, regression outputs, etc.). In some embodiments, an AI model comprises algorithms and parameters that are trained on large datasets to enable it to generalize from the data and apply learned knowledge to new, unseen data. In some embodiments, an AI model is used to solve problems like classification, regression, clustering, and/or anomaly detection.

As used herein and in the claims, “unmanned vehicle” refers to a vehicle that operates without a human pilot, driver, or operator onboard. In some embodiments, it is remotely controlled, semi-autonomous, or fully autonomous, depending on its level of automation and control systems. In some embodiments, unmanned vehicles operate in various environments, including air (Unmanned Aerial Vehicles—UAVs/drones), land (Unmanned Ground Vehicles—UGVs), water (Unmanned Surface Vehicles—USVs), and underwater (Unmanned Underwater Vehicles—UUVs). As used herein and in the claims, if a camera is mounted or installed to an unmanned vehicle, the camera becomes an “unmanned-vehicle-mounted camera” or “onboard camera”.

As used herein and in the claims, “unmanned equipment” refers to any hardware and sensors that perform data collection, imaging, monitoring, or computational tasks autonomously or through remote control without direct human intervention during its primary function. In some embodiments, unmanned equipment includes Unmanned Aerial Vehicles (UAVs), Unmanned Ground Vehicles (UGVs), Single-Lens Reflex (SLR) cameras, and mobile phones.

As used herein and in the claims, “imaging device” refers to a hardware system designed to capture, record, or process visual data in the form of images or videos. In some embodiments, imaging devices use various technologies such as optical sensors, infrared, LiDAR, multispectral, or thermal imaging to acquire data from the environment. In some embodiments, these devices can be integrated into UAVs, UGVs, or mobile phones.

As used herein and in the claims, “annotate” and “label” are used interchangeably. They (or any related forms such as “annotation,” “annotating,” “labelling,” and “labeling”) refer to the process or act of marking data, such as images, text, or sensor outputs, with relevant information to facilitate analysis, training, or decision-making. In some embodiments, “annotate” refer to manually and/or automatically labeling images with defect categories (e.g., cracks, spalling, moisture) to create structured training data for machine learning models. In some embodiments, annotation may include bounding boxes, segmentation masks, key points, and/or metadata to enhance detection accuracy and model performance.

As used herein and in the claims, the term “training” (or any related forms such as “trained,” “trains,” and “train”) refers to the process or act of teaching an artificial intelligence model to recognize patterns, make predictions, or perform tasks by exposing it to large amounts of labeled data. In some embodiments, during training, the model adjusts its internal parameters (such as weights in neural networks) to minimize errors in its predictions. This is done using optimization algorithms that iteratively improve the model's performance on the given data. In some embodiments, the training process involves feeding input data, comparing model predictions to the correct outputs (labels/annotations), and updating the model based on the discrepancy between predicted and actual results.

As used herein and in the claims, the term “YOLOv6 model” refers to YOLOv6 (You Only Look Once version 6), an object detection model designed for real-time applications. It incorporates backbone networks, anchor-free detection heads, and optimization techniques to achieve high-speed, high-accuracy performance. As used herein and in the claims, “YOLOv6” is used interchangeably with “YOLOv6 model” and, unless stated otherwise, “YOLOv6” also includes its different variations, such as YOLOv6-N (Nano), YOLOv6-S(Small), YOLOv6-M (Medium), YOLOv6-L (Large), and/or YOLOv6-X (Extra Large).

As used herein and in the claims, the term “digital twin” refers to a virtual representation of a physical object, system, or process that may be updated with real-time data to simulate, analyze, and optimize performance. In some embodiments, digital twin modules integrate sensor data, AI models, and simulation techniques to provide insights for monitoring, diagnostics, predictive maintenance, and decision-making. In some embodiments, a digital twin module involves a web use interface (UI) platform hosted on a server for online real-time visits both on mobile devices and computers.

As used herein and in the claims, the term “GIS” refers to Geographic Information System, a framework for capturing, storing, analyzing, managing, and visualizing spatial or geographic data. In some embodiments, GIS integrates various data types, such as maps, satellite imagery, sensor data, and attribute information, to provide insights about geographical locations and patterns. In some embodiments, GIS allows users to analyze spatial relationships, create maps, and make data-driven decisions. In some embodiments, GIS is used to manage and visualize geo-referenced data to understand spatial phenomena and support decision-making processes. In some embodiments, WebGIS is GIS accessible and interactive through web-based platforms, such as GIS hosted on a cloud server, allowing users to access, view, analyze, and share spatial data via the internet.

As used herein and in the claims, the term “geo-reference” (or any related forms such as “geo-references,” “geo-referencing”, and “geo-referenced”) refers to the process or act of associating data, such as images, maps, digital models or objects, with real-world geographic coordinates or a known spatial reference system. This process enables accurate positioning, alignment, visualization, interaction, and analysis of data in relation to the Earth's surface.

As used herein and in the claims, the term “individual-annotating” (or any related forms such as “individual-annotate,” “individual-annotation”, and “individual-annotates”) refers to the process or act of each individual person independently labels their assigned images by marking defects. The process or act can be manual, automatic, or or a combination of both.

As used herein and in the claims, the term “cross-verifying” (or any related forms such as “cross-verify,” “cross-verification,” and “cross-verifies”) refers to the process or act of validating or confirming the accuracy, consistency, or reliability of information, data, or results by comparing them with independent sources, methods, or reference points. The process or act can be manual, automatic, or or a combination of both. In some embodiments, cross-verifying is conducted by exchanging individual-annotated data between individual annotators and letting them validate or confirm each other's annotations, correcting any discrepancies, such as shifts in bounding box positions or misclassification of defects.

As used herein and in the claims, the term “expert-reviewing” (or any related forms such as “expert-review,” “expert-reviews,” and “expert-reviewed”) refers to a systematic evaluation of data, processes, or outcomes conducted by a subject matter expert to ensure accuracy, reliability, and compliance with established standards or best practices. In some embodiments, expert-reviewing involves industry professionals, such as architecture professors and staff from the housing department of the government, reviewing the annotations, with a focus on complex defect patterns, such as dense cracking or regions where multiple defects coexisted (e.g., peeling with dampness).

As used herein and in the claims, the term “register” (or any related forms such as “registration,” “registered,” and “registering”) refers to the process or act of aligning or mapping image data and/or image segment data to a geo-referenced model or spatial reference system in such a way that the image and/or image segment coordinates correspond accurately to the physical coordinates of the model or spatial reference system.

As used herein and in the claims, the term “visualize” (or any related forms such as “visualization,” “visualizing,” and “visualized”) refers to the process or act of representing data, models, or simulations in a visual format, such as 2D or 3D graphics, to facilitate data management, interactive operation, understanding, analysis, and/or decision-making. In some embodiments, visualization refers to the display or manipulation of real-time or historical data of a physical object, system, and/or process as a digital representation, often in the form of interactive 3D models, dashboards, charts, or augmented reality. In some embodiments, visualization helps users monitor performance, find anomalies, and predict future behaviors by presenting complex data in a comprehensible and actionable manner.

As used herein and in the claims, the term “segment” refers to a region or portion of an image that has been isolated or separated based on certain characteristics such as color, texture, intensity, shape and/or meaning. In some embodiments, each segment in the image represents a meaningful structure or object, such as a building facade, defect, or region of interest.

### NUMBERED EMBODIMENTS

Embodiment 1. A system for automated inspection of a defect of a façade of a building, comprising:
an image processing module that processes at least one input image of at least a portion of the façade of the building obtained from an imaging device,
wherein the image processing module comprises an AI model that is configured to analyze the at least one input image to identify at least one identified defect segment in at least one identified defect image; and
a digital twin module that comprises a geo-reference submodule; a registration submodule; and a visualization submodule, which are connected with each other,
wherein the geo-reference submodule is configured to geo-reference a 3D model of the building to obtain a geo-referenced 3D model,
wherein the registration submodule is configured to register the at least one identified defect image and the at least one identified defect segment to the geo-referenced 3D model to obtain at least one registered defect image and at least one registered defect segment,
and wherein the visualization submodule is configured to visualize the at least one registered defect image, at least one the registered defect segment and the geo-referenced 3D model such that the defect of the façade of the building is automatedly inspected through the at least one visualized registered defect segment, the at least one visualized registered defect image, and the visualized geo-referenced 3D model.

Embodiment 2. The system of embodiment 1, further comprising:
an image acquisition module that is configured to be executed by at least one unmanned equipment to obtain at least one training image of at least a portion of the façade of the building, and
wherein the image processing module further comprises a training submodule that is configured to train the AI model based on the at least one training image.

Embodiment 3. The system of any one of above embodiments, wherein the image acquisition module is configured to operate the at least one unmanned equipment to obtain the at least one training image along a pre-determined path such that the at least one training image covering at least a portion of the façade of the building is obtained.

Embodiment 4. The system of any one of above embodiments, wherein the at least one unmanned equipment is at least one unmanned aerial vehicle (UAV), wherein the at least one UAV is configured to be mounted with an unmanned-vehicle-mounted camera, and wherein the pre-determined path is a pre-determined flight path.

Embodiment 5. The system of any one of above embodiments, wherein the AI model comprises a YOLOv6 model.

Embodiment 6. The system of any one of above embodiments, wherein the imaging device comprises a camera, a smartphone, and/or an unmanned-vehicle-mounted camera.

Embodiment 7. The system of any one of above embodiments, wherein the training submodule further comprises:
a first-round annotation component;
a second-round annotation component;
a third-round annotation component;
an annotation validation component; and
an annotation revision component,
wherein the first-round annotation component, the second-round annotation component, the third-round annotation component are configured to sequentially annotate the at least one training image based on the defect to obtain an at least one annotated training image, and
wherein the annotation validation component is configured to determine whether the at least one annotated training image satisfies a predetermined annotation performance condition,
if yes, the annotation validation component is configured to output the at least one annotated training image,
otherwise, the annotation validation component is configured to iteratively activate the annotation revision component and the third-round annotation component to re-annotate the at least one training image until the at least one annotated training image satisfies the predetermined annotation performance condition.

Embodiment 8. The system of any one of above embodiments, wherein the first-round annotation component is configured to perform individual-annotation, wherein the second-round annotation component is configured to perform cross-verification, and wherein the third-round annotation component is configured to perform expert-review.

Embodiment 9. The system of any one of above embodiments, wherein the training submodule further comprises:
a model training component;
a model validation component; and
a backpropagation component,
wherein the model training component is configured to train the AI model based on the at least one annotated training image,
and wherein the model validation component is configured to determine whether the AI model stratifies a predetermined model performance condition,
if yes, the model validation component is configured to deploy the AI model,
otherwise, the model validation component is configured to iteratively activate the backpropagation component to adjust the AI model and activate the model training component to re-train the AI model until the AI model stratifies the predetermined model performance condition.

Embodiment 10. A method of automated inspection of a defect of a façade of a building using a system of any one of above embodiments, the method comprising the steps of:
(a) processing, by an image processing module, at least one input image of at least a portion of the façade of the building obtained from an imaging device;
wherein the step (a) further comprises the step of:
(a1) analyzing, by an AI model, the at least one input image to identify at least one identified defect segment in at least one identified defect image;
(b) geo-referencing, by a geo-reference submodule, a 3D model of the building to obtain a geo-referenced 3D model;
(c) registering, by a registration submodule, the at least one identified defect image and the at least one identified defect segment to the geo-referenced 3D model to obtain at least one registered defect image and at least one registered defect segment; and
(d) visualizing, by a visualization submodule, the at least one registered defect image, the at least one registered defect segment, and the geo-referenced 3D model such that the defect of the façade of the building is automatedly inspected through the at least one visualized registered defect segment, the at least one visualized registered defect image, and the visualized geo-referenced 3D model.

Embodiment 11. The any one of above embodiments,
wherein the system further comprises an image acquisition module configured to be executed by at least one unmanned equipment,
wherein the image processing module further comprises a training submodule,
and wherein the method further comprises the steps of:
(1) obtaining, by the image acquisition module, at least one training image of at least a portion of the façade of the building; and
(2) training, by the training submodule, the AI model based on the at least one training image.

Embodiment 12. The method of any one of above embodiments, wherein step (1) obtaining the at least one training image comprises the step of:
(1.1) operating, by the image acquisition module, the at least one unmanned equipment to obtain the at least one training image along a pre-determined path such that the at least one training image covering at least a portion of the façade of the building is obtained.

Embodiment 13. The method of any one of above embodiments,
wherein the at least one unmanned equipment is at least one unmanned aerial vehicle (UAV),
wherein the at least one UAV is configured to be mounted with an unmanned-vehicle-mounted camera,
and wherein step (1.1) operating the at least one unmanned equipment comprises the step of:
(1.1.1) operating, by the image acquisition module, the at least one UAV mounted with an unmanned-vehicle-mounted camera to obtain the at least one training image along a pre-determined flight path such that the at least one training image covering at least a portion of the façade of the building is obtained.

Embodiment 14. The method of any one of above embodiments, wherein the AI model comprises a YOLOv6 model.

Embodiment 15. The method of any one of above embodiments, wherein the imaging device comprises camera, smartphone, and/or unmanned-vehicle-mounted camera.

Embodiment 16. The method of any one of above embodiments, wherein the training submodule comprises:
a first-round annotation component;
a second-round annotation component;
a third-round annotation component;
an annotation validation component; and
an annotation revision component,
and wherein the step (2) training the AI model comprises the steps of:
(2.1) sequentially annotating, by the first-round annotation component, the second-round annotation component and the third-round annotation component, the at least one training image based on the defect to obtain an at least one annotated training image;
(2.2) determining, by the annotation validation component, whether the at least one annotated training image satisfies a predetermined annotation performance condition,
if yes, proceeding with step (2.3);
if not,
(2.2.1) activating, by the annotation validation component, the annotation revision component and the third-round annotation component;
(2.2.2) re-annotating, by the third-round annotation component, the at least one training image;
(2.2.3) repeating steps (2.2)-(2.2.3) until the at least one annotated training image satisfies the predetermined annotation performance condition; and
(2.3) outputting, by the annotation validation component, the at least one annotated training image.

Embodiment 17. The method of any one of above embodiments, wherein step (2.1) sequentially annotating the at least one training image comprises the steps of:
(2.1.1) individual-annotating, by the first-round annotation component, the at least one training image to obtain at least one first-round annotated training image;
(2.1.2) cross-verifying, by the second-round annotation component, the at least one first-round annotated training image to obtain at least one second-round annotated training image; and
(2.1.3) expert-reviewing, by the third-round annotation component, the at least one second-round annotated training image to obtain the at least one annotated training image.

Embodiment 18. The method of any one of above embodiments, wherein the training submodule further comprises:
a model training component;
a model validation component; and
a backpropagation component, and wherein step (2) training the AI model further comprises the steps of:
(2.4) training, by the model training component, the AI model based on the at least one annotated training image;
(2.5) determining, by the model validation component, whether the AI model stratifies a predetermined model performance condition,
if yes, proceeding with step (2.6);
if not,
(2.5.1) activating, by the model validation component, the backpropagation component;
(2.5.2) adjusting, by the backpropagation component, the AI model;
(2.5.3) re-training, by the model training component, the AI model;
(2.5.4) repeating steps (2.5)-(2.5.4) until the AI model stratifies the predetermined model performance condition; and
(2.6) deploying, by the model validation component, the AI model.

Embodiment 19. A non-transitory computer-readable medium storing at least one computer program for implementing a method of automated inspection of a defect of a façade of a building of any one of above embodiments, the computer-readable medium comprising:
(a) program instructions for processing, by an image processing module, at least one input image of at least a portion of the façade of the building obtained from an imaging device,
wherein program instructions (a) further comprise:
(a1) program instructions for analyzing, by an AI model, the at least one input image to identify at least one identified defect segment in the at least one identified defect image;
(b) program instructions for geo-referencing, by a geo-reference submodule, a 3D model of the building to obtain a geo-referenced 3D model;
(c) program instructions for registering, by a registration submodule, the at least one identified defect image and the at least one identified defect segment to the geo-referenced 3D model to obtain at least one registered defect image and at least one registered defect segment; and
(d) program instructions for visualizing, by a visualization submodule, the at least one registered defect image, the at least one registered defect segment, and the geo-referenced 3D model such that the defect of the façade of the building is automatedly inspected through the at least one visualized registered defect segment, the at least one visualized registered defect image, and the visualized geo-referenced 3D model.

Embodiment 20. The computer-readable medium of any one of above embodiments,
wherein the system further comprises an image acquisition module configured to be executed by at least one unmanned equipment,
wherein the image processing module further comprises a training submodule,
and wherein the computer-readable medium further comprises:
(1) program instructions for obtaining, by the image acquisition module, at least one training image of at least a portion of the façade of the building;
(2) program instructions for training, by the training submodule, the AI model based on the at least one training image.

Embodiment 21. The computer-readable medium of any one of above embodiments, wherein program instructions (1) for obtaining the at least one training image comprise:
(1.1) program instructions for operating, by the image acquisition module, the at least one unmanned equipment to obtain the at least one training image along a pre-determined path such that the at least one training image covering at least a portion of the façade of the building is obtained.

Embodiment 22. The computer-readable medium of any one of above embodiments, wherein the at least one unmanned equipment is at least one unmanned aerial vehicle (UAV), wherein the at least one UAV is configured to be mounted with an unmanned-vehicle-mounted camera, and wherein program instructions (1.1) comprise:

(1.1.1) program instructions for operating, by the image acquisition module, the at least one UAV mounted with an unmanned-vehicle-mounted camera to obtain the at least one training image along a pre-determined flight path such that the at least one training image covering at least a portion of the façade of the building is obtained.

Embodiment 23. The computer-readable medium of any one of above embodiments, wherein the AI model comprises a YOLOv6 model.

Embodiment 24. The computer-readable medium of any one of above embodiments, wherein the imaging device comprises camera, smartphone, and/or unmanned-vehicle-mounted camera.

Embodiment 25. The computer-readable medium of any one of above embodiments, wherein the training submodule comprises:
a first-round annotation component;
a second-round annotation component;
a third-round annotation component;
an annotation validation component; and
an annotation revision component,
and wherein program instructions (2) for training the AI model comprise:
(2.1) program instructions for sequentially annotating, by the first-round annotation component, the second-round annotation component and the third-round annotation component, the at least one training image based on the defect to obtain an at least one annotated training image;
(2.2) program instructions for determining, by an annotation validation component, whether the at least one annotated training image satisfies a predetermined annotation performance condition, if yes, proceeding with executing program instructions (2.3);
(2.2.1) program instructions for, if not, activating, by the annotation validation component, an annotation revision component and the third-round annotation component;
(2.2.2) program instructions for re-annotating, by the third-round annotation component, the at least one training image;
(2.2.3) program instructions for repeatedly executing program instructions (2.2)-(2.2.3) until the at least one annotated training image satisfies the predetermined annotation performance condition; and
(2.3) program instructions for outputting, by the annotation validation component, the at least one annotated training image.

Embodiment 26. The computer-readable medium of any one of above embodiments, wherein program instructions (2.1) for sequentially annotating the at least one training image comprise:
(2.1.1) program instructions for Individual-annotating, by the first-round annotation component, the at least one training image to obtain at least one first-round annotated training image;
(2.1.2) program instructions for cross-verifying, by the second-round annotation component, the at least one first-round annotated training image to obtain at least one second-round annotated training image; and
(2.1.3) program instructions for expert-reviewing, by the third-round annotation component, the at least one second-round annotated training image to obtain the at least one annotated training image.

Embodiment 27. The computer-readable medium of any one of above embodiments, wherein the training submodule further comprises:
a model training component;
a model validation component; and
a backpropagation component,
and wherein program instructions (2) for training the AI model further comprise:
(2.4) program instructions for training, by the model training component, the AI model based on the at least one annotated training image;
(2.5) program instructions for determining, by the model validation component, whether the AI model stratifies a predetermined model performance condition,
if yes, proceeding with executing program instructions (2.6);
(2.5.1) program instructions for, if not, activating, by the model validation component, the backpropagation component;
(2.5.2) program instructions for adjusting, by the backpropagation component, the AI model;
(2.5.3) program instructions for re-training, by the model training component, the AI model;
(2.5.4) program instructions for repeatedly executing program instructions (2.5)-(2.5.4) until the AI model stratifies the predetermined model performance condition; and
(2.6) program instructions for deploying, by the model validation component, the AI model.

### EXAMPLES

The following example embodiments alone or in combination may be practiced to provide a system and method of artificial intelligence (AI) based image processing and digital twin visualization for automated detection and registration of building façade defects. Particularly, provided systems, methods and computer-readable media involve:
A. In some embodiments, provided are automatic AI-based defect inspection (such as detection) systems, methods, and computer readable media that can classify the defects on the aerial images efficiently.
B. In some embodiments, provided are automated 2D and 3D data processing systems, methods, and computer readable media to process the result from AI-based defect inspection. Also, a web UI platform is hosted on the server for online real-time visits both on mobile device and computer.

### Example 1—Systems

### 1.1 System Architecture

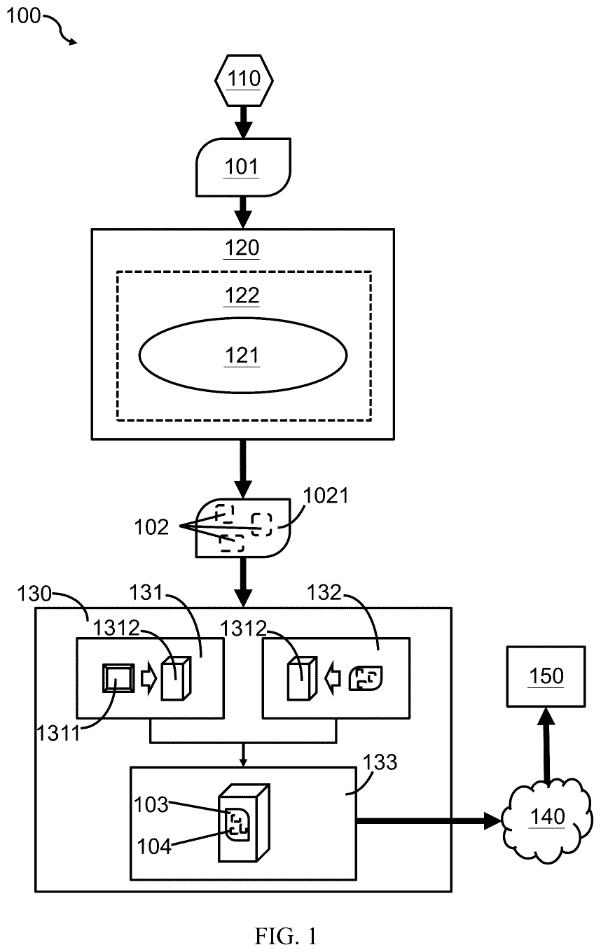

Now referring to FIG. 1, showing an example automated building façade defects inspection system 100. In this example, the system 100 generally contains an image acquisition module 110, an image processing module 120 and a digital twin module 130, which are sequentially connected with each other. The image acquisition module 110 is configured to be executed by an unmanned equipment, which is mounted with an imaging device, to obtain image dataset 101 of the target building façade. In this example, the image dataset 101 includes input images and training images.

In this example, unmanned equipment is Unmanned Aerial Vehicles (UAVs) such that the input images and training images in the image dataset 101 are obtained along a pre-determined path (such as flight path) for imaging the façade of the building. The imaging device is high-resolution cameras mounted and connected with UAVs. In some examples, the imaging device can be a camera, a Single-Lens Reflex (SLR) camera, a smartphone, and/or an unmanned-vehicle-mounted camera (e.g. UAV, UGV, etc.).

In some examples, the image acquisition module 110 obtains the input images and/or training images in the image dataset 101 independently and/or sequentially. The image processing module 120 processes the input images and/or training images in the image dataset 101 independently and/or sequentially. In some examples, multiple input images and/or training images in the image dataset 101 are obtained and/or processed by the image processing module 110 and/or the image processing module 120 as a batch.

In this example, the image processing module 120 processes image dataset 101 that includes input images and training images of at least a portion of the façade of the building obtained from high-resolution cameras mounted on the UAVs. The image processing module 120 contains an AI model 121 that is configured to analyze the images in the image dataset 101 to identify the defect segments 102 in the images of the image dataset 101. The images that contain any of identified defect segments 102 become identified defect images 1021. In this example, the AI model 121 comprises a YOLOv6 model. In some examples, the AI model 121 can be any one of the neural network models and machine learning algorithms that generally performs image analyzing functions, such as feature extraction, image transformation, object detection and classification, on the input images and/or training images in the image dataset 101 to obtain one or more identified defect segments 102 and identified defect image 1021.

In this example, the image processing module 120 comprises a training submodule 122 that is configured to train the AI model 121 based on the training images in the image dataset 101. This will be described with more details in the following sections.

In this example, the digital twin module 130 is configured to receive the identified defect segments 102, the identified defect images 1021 from the image processing module 120 to register and visualize them for further building maintenance and/or management purposes. The digital twin module 130 generally contains a geo-reference submodule 131, a registration submodule 132 and a visualization submodule 133, which are connected with each other. The geo-reference submodule 131 is configured to geo-reference a 3D model 1311 of the building to a certain geographic coordinate system, such as the WGS 84 (World Geodetic System 1984), to obtain a geo-referenced 3D model 1312. The registration submodule 132 is configured to register the identified defect segments 102 and the identified defect images 1021 to the geo-referenced 3D model 1312 to obtain registered defect images 103 and registered defect segments 104. In this example, the visualization submodule 133 is configured to visualize the registered defect images 103, registered defect segments 104 and geo-referenced 3D model of the building thereof such that the defect of the façade of the building is automatedly inspected through the visualized registered defect segments 104, the visualized registered defect images 103, and the visualized geo-referenced 3D model 1312 that can be accessed through the internet 140 on a terminal device 150, such as a computer, a smartphone, a tablet etc. In some embodiments, the visualization submodule 133 is a WebGIS platform.

In some embodiments, the geographic coordinate system used by the geo-reference submodule 131 for geo-referencing a 3D model of the building is other commercially available geographic coordinate system such as NAD 83 (North American Datum 1983), NAD 27 (North American Datum 1927), ETRS89 (European Terrestrial Reference System 1989), GDA 2020 (Geocentric Datum of Australia 2020), CGCS 2000 (China Geodetic Coordinate System 2000), PZ-90 (Parametry Zemli 1990) or WGS84 (World Geodetic System 1984). In some embodiments, the 3D model 1311 is or contains CAD Model (Computer-Aided Design Model), BIM Model (Building Information Model), Mesh Model (Triangular or Polygonal Mesh), and/or Point Cloud Model.

In some embodiments, the system 100 is a computer system comprising at least one processer coupled with a memory that stores an executable software program, wherein the executable software program comprises any one or more of the systems and modules described herein or combination thereof.

### 1.2 Image Acquisition Module

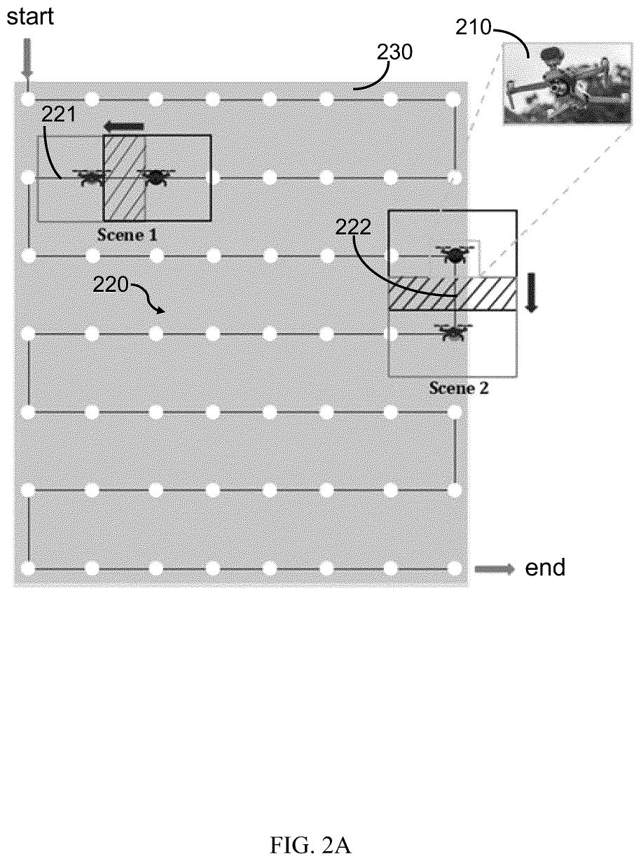

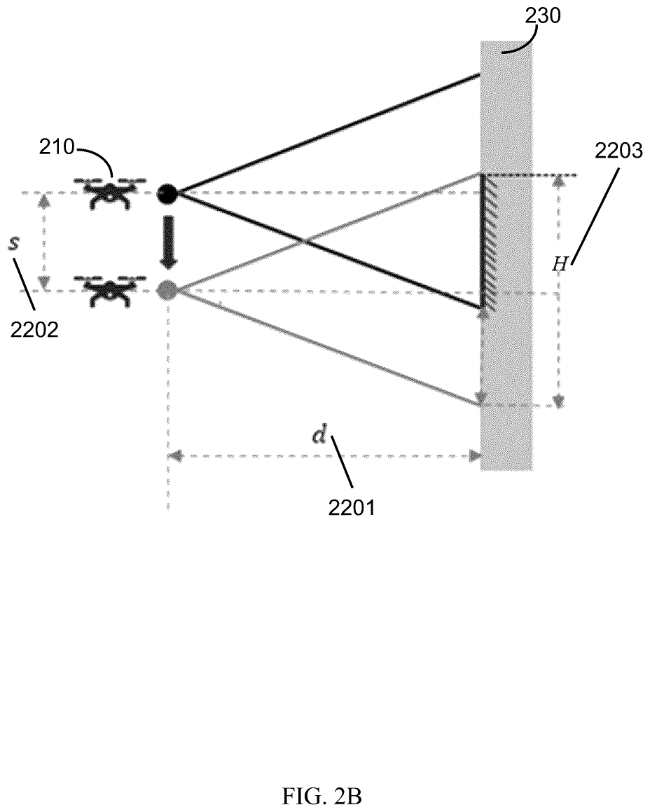

Now referring to FIGS. 2A and 2B with reference to FIG. 1, showing an example method of obtaining the image dataset 101 by UAVs 210 moving along a predetermined flight path 220 is disclosed. In this example, the image dataset is a dataset including high-resolution images. In some examples, this dataset was collected and produced by using unmanned equipment (UAVs, UGVs, SLRs and mobile phones). Based on this dataset, AI model 121 or a robust deep neural network model is trained as real building defect detection model. Any defects in the target building are detected, localized, and classified after being processed by said trained model.

In this example, a robust deep neural network requires a highly standardized and representative dataset. To address this, the image dataset 101 is configured to be a self-constructed dataset by rigorously selecting defect categories based on BSI standards (e.g., BS 8210 for surface defects) and governmental Buildings Department reports, which prioritize visible and high-impact defects in aging structures. For illustrative purpose, this example used cracks, spalling, and moisture as example target defects. These demonstrative choices of example target defects align with two additional criteria including the drone-compatible detectability and maintenance urgency.

These defects exhibit distinct visual signatures (e.g., linear cracks, irregular spalling patches, moisture-induced discoloration) that are effectively captured by UAV-mounted high-resolution cameras (typically set at 24 Megapixels (6000×4000 pixels) or higher, providing a ground sampling distance (GSD) of 1 cm/pixel or less) and LiDAR sensors, even in dense urban environments. Besides, these defects are frequently cited in governmental building inspection guidelines as primary indicators of structural deterioration, requiring timely intervention to prevent safety risks.

By incorporating governmental Institute of Surveyors recommendations, the image dataset 101 is configured to ensure relevance to local regulatory frameworks. While other examples may expand to additional defect types (e.g., corrosion, hollowing), this example optimizes model accuracy for automated UAV-based inspections targeting the most prevalent and actionable defects.

The self-constructed dataset features images of old buildings in the city area captured via UAVs and Digital Single-Lens Reflex cameras (DSLRs), highlighting defects including cracks, spalling, and moisture. Challenges included dense urban environments and narrow spaces. To address these, the predetermined flight path 220 for imaging the façade of the building was configured to be an energy-efficient UAV flight path optimized for systematic coverage as in FIG. 2A. Along the building surface 230, the UAVs 210 track the horizontal path 221 or vertical path 222.

FIG. 2B showed the right side view of the scene as shown in FIG. 2A, wherein the UAVs 210 track the vertical path 222 along the building façade or surface 230.

Some parameters of UAV data collection predetermined flightpath 220 include but not limited to:

Distance between UAVs 210 and building façade or surface 230 (d) 2201: Maintained at d=10 (10,000 mm) to balance image resolution and safety in confined spaces.

Vertical waypoint interval(s) 2202: Set to s=3 m, ensuring 30% horizontal overlap between adjacent images.

Vertical Field of View (FOV) coverage (H) 2203: Calculated as H=(h·d)/f, where:
h=13.0 mm (sensor heigh),
f=24 mm (lens focal length).

For d=10, H=13.0×10,000/24≈5,417 mm≈5.4 m.

In this example, this parameterized approach ensured comprehensive coverage with minimal labor costs while aligning data acquisition with downstream AI detection and digital twin registration workflows. Each image's geographic position (from UAV GPS/IMU) and camera parameters (h,f,d) are input to Algorithm 1 (as shown in Table 2) in the registration submodule 132 to compute the façade's normal vector (m) and registers the identified defect segments 102 onto the geo-referenced 3D model 1312, which will be described in more details subsequently.

In some embodiments, the parameters of the predetermined flightpath 220 are different from those in the example provided herein and customized according to different conditions or requirements for image data acquisition of the system, such as different image quality requirements of the image dataset, different conditions of the building façade, areas of interest of the building façade, camera conditions, or UAV conditions.

### 1.3 Image Processing Module-AI Model and Training Submodule

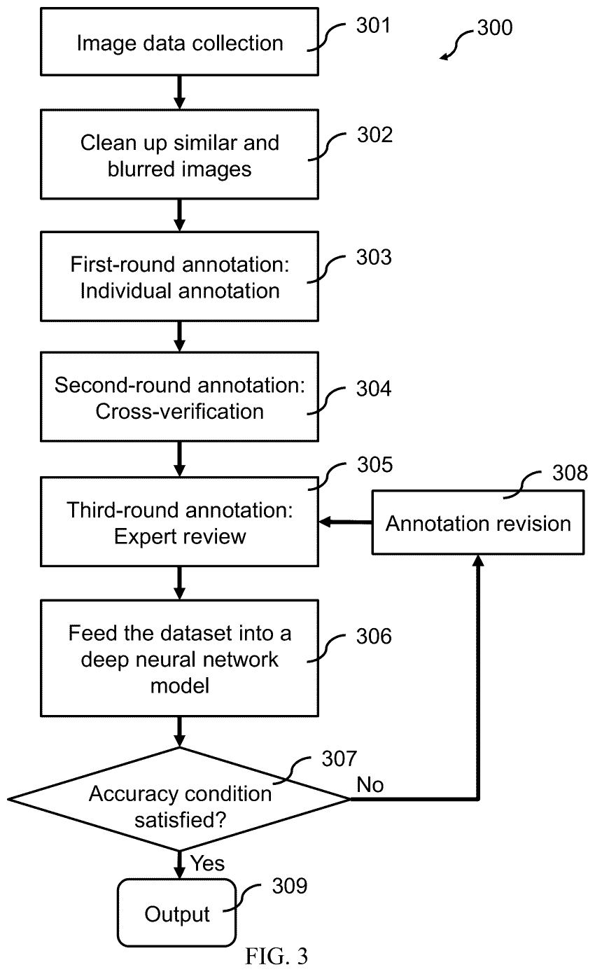

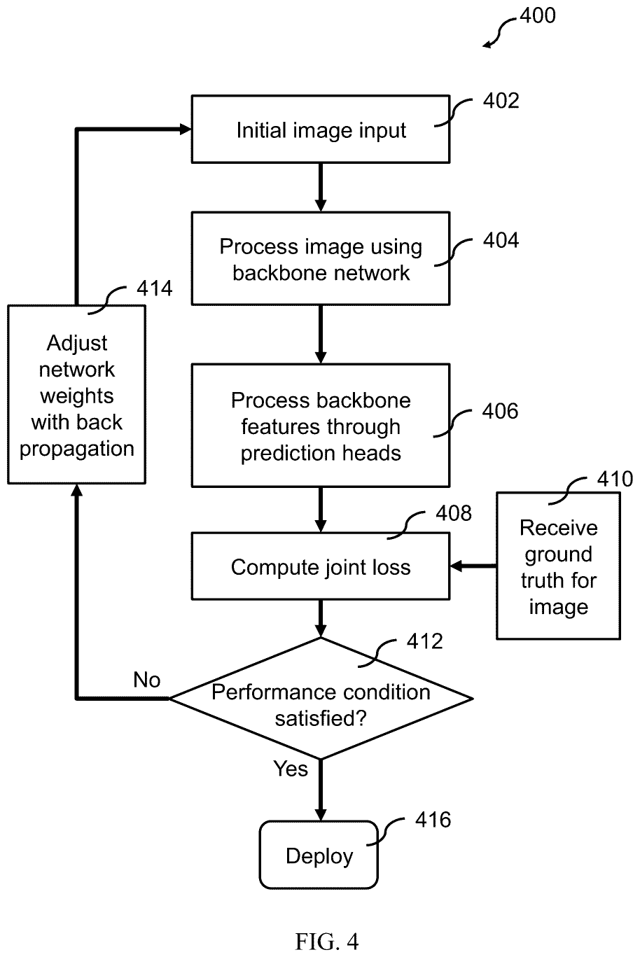

Now referring to FIGS. 3 and 4 with reference to FIG. 1, showing an example workflow of data annotation and model training and deployment of the training submodule 122. In this example, the training submodule 122 is configured to train and/or deploy the AI model 121 based on the training images from the image dataset 101.

### 1.3.1 Image Annotation

Now referring to FIG. 3 with reference to FIG. 1, showing an example workflow 300 of the training submodule 122 for annotating the training images. In this example, the training submodule 122 generally includes a first-round annotation component, a second-round annotation component, a third-round annotation component, an annotation validation component, and an annotation revision component. The first-round annotation component is configured to perform individual-annotation. The second-round annotation component is configured to perform cross-verification. The third-round annotation component is configured to perform expert-review. The first-round annotation component, the second-round annotation component, the third-round annotation component are configured to sequentially annotate the at least one training image based on the defect to obtain an at least one annotated training image. The annotation validation component is configured to determine whether the at least one annotated training image satisfies a predetermined annotation performance condition. If yes, the annotation validation component is configured to output the at least one annotated training image; if not, the annotation validation component is configured to iteratively activate the annotation revision component and the third-round annotation component to re-annotate the at least one training image until the at least one annotated training image satisfies the predetermined annotation performance condition.

In this example, the training submodule 122 is configured to execute an initial data cleaning step 302 that is configured to receive the image dataset 101 from the data acquisition module 110, which is configured to execute the image data collection step 301. The initial data cleaning step 302 is configured to remove unusable images, such as those lacking targeted defects or those affected by motion blur. This refinement resulted in a cleaned image dataset of 5,527 high-definition images, ensuring that the data maintained high quality and relevance for subsequent model training and analysis.

In this example, the training submodule 122 is configured to use the Pascal VOC format for annotation, adhering to strict guidelines designed to ensure the accuracy and consistency of the labeled data. The annotation process was carried out in three distinct rounds: individual-annotation, cross-verification, and expert-review. Annotation tools such as Labellmg facilitated the labeling process, generating XML files that detailed defect labels and associated image information, thus ensuring that the dataset annotations were of sufficient quality for effective model training.

In this example, the training submodule is configured to execute the labeling process with following parameters:

Image Size: The image dataset consisted of high-resolution images, primarily in 4K resolution (3840×2160 pixels), ensuring fine-grained defect detection.

Defect Size: The defects ranged in size, with some being quite small (e.g., cracks or paint chips), while others were more prominent (e.g., large areas of peeling or water damage). The defect-to-image size ratio varied but typically ranged from 1% to 10% of the total image area for smaller defects. Larger defects, such as peeling, often accounted for 10% to 30% of the image area.

Color: The majority of the images were in color, which was essential for accurately detecting defects based on color contrasts and nuances, particularly for defects like fading or moisture stains.

In this example, the AI model 121 is trained and validated based on the finalized image dataset, which includes the annotated training images. After finalizing the cleaned image dataset from 302, the AI model or AI-based automatic defect detection algorithm was validated for defect identification (such as classification) based on the finalized image dataset. The production process of the finalized dataset is depicted in FIG. 3.

In this example, the training submodule 122 is configured to execute three rounds of annotation of the images in the cleaned image dataset from 302, which includes the training images.

### Step 303: First Round Annotation (Individual-Annotation)

The first round annotation component is configured to label each image in the cleaned image dataset from 302 by knowledge of a team member independently by marking defects such as cracks, peeling, and dampness. These annotations were recorded in the Pascal VOC format, which includes the bounding box coordinates and defect category labels.

### Step 304: Second Round Annotation (Cross-Verification)

In this round, the second round annotation component is configured to exchange first round annotated images from 303 between team members, and cross-verify the first round annotated images for each other's annotations with each other's knowledge, correcting any discrepancies, such as shifts in bounding box positions (>5%) or misclassification of defects.

### Step 305: Third Round Annotation (Expert Review)

In this final round, the third-round annotation component is configured to review the second round annotated images from 304 by knowledge of industry professionals-such as architecture professors and staff from the Housing Department, with a focus on complex defect patterns, such as dense cracking or regions where multiple defects coexisted (e.g., peeling with dampness). This step ensured the highest level of annotation accuracy.

### Feedback Loop Mechanism 305-306-307-308-305:

Step 306: The annotation validation component is configured to validate the third round annotated images from 305 by the deep neural network model with a predetermined annotation performance condition, such as an accuracy condition.

Step 307: The annotation validation component is configured to determine if the annotated image makes the model's validation metrics (e.g., mAP) meet the established threshold (75%). If yes, the annotation validation component proceeds to step 309, which is configured to output the annotated image. If not, the annotation validation component automatically activates the annotation revision component and the third round annotation component, triggering the annotation revision step 308 and expert review in 305.

Steps 308 and 305: The annotation revision component is configured to receive, from 306, low-confidence detection results (confidence <0.6) from the deep neural network model validation, along with false positives or missed defects. The third round annotation component is then configured to review the original annotations of the identified problem samples by the knowledge of team members and experts, correcting errors or adding missing defects based on the model's feedback. The third round annotation component is configured to reintroduce the corrected annotations into the dataset and use them to fine-tune the neural network, creating a “Labeling-Validation-Revision” feedback loop. This iterative process ensures the continuous improvement of the dataset, with the goal of enhancing defect detection accuracy over time.

Step 309: The annotation validation component outputs the annotated image to the finalized image dataset, which includes the annotated training images for AI model training.

### 1.3.2 AI Model and Training

Now referring to FIG. 4 with reference to FIGS. 1 and 3, showing an example workflow 400 of the training submodule 122 for training and/or deploying the AI model 121. In this example, the training submodule further includes: a model training component, a model validation component, and a backpropagation component. The model training component is configured to train the AI model 121 based on the annotated training image. The model validation component is configured to determine whether the AI model 121 stratifies a predetermined model performance condition. If yes, the model validation component is configured to deploy the AI model 121; if not, the model validation component is configured to iteratively activate the backpropagation component to adjust the AI model 121 and activate the model training component to re-train the AI model 121 until the AI model 121 stratifies the predetermined model performance condition.

In this example, the AI model 121 includes a YOLOv6 model. Experimental overall results below showed the process of selecting YOLOv6 model as part of the AI model 121 and the performance of the YOLOv6 model and other comparing models based on the finalized image dataset thereof.

In this example, the training submodule 122 in the initial image input step 402 is configured to receive the finalized image dataset from 300 and split the dataset into three parts based on a random stratified selection to ensure that the distribution of defects was consistent across all sets: 72% (3,980 images) for training, 8% (442 images) for validation, and 20% (1,105 images) for robustness testing. This splitting was based on maintaining a balance in defect types and image conditions across the different datasets to ensure that the model's performance was generalized across various scenarios. The division was done in a way that the validation and testing datasets had diverse samples to evaluate the model's ability to handle edge cases and unseen data.

Then, in the experiment of this example, the training submodule is configured to feed the training set to more than 20 models for training and select the model with the strongest performance as the model for building scene detection. The benchmark experiments results are demonstrated in Table 1.

TABLE 1
Benchmark experiments results of using different AI models.
The test results of selected models based on CUBIT-Det

| | | | | Crack | | Spalling | | Moisture | |
|---|---|---|---|---|---|---|---|---|---|
| Model | Backbone | mAP [symbol] ↑ | mAP [symbol] ↑ | AP [symbol] ↑ | AP [symbol] ↑ | AP [symbol] ↑ | AP [symbol] ↑ | AP [symbol] ↑ | AP [symbol] ↑ |
| YOLOv5-n | New CSP-Darknet | 73.4% | 39.9% | 68.8% | 35.6% | 81.9% | 49.9% | 69.4% | 34.4% |
| YOLOv5-s | New CSP-Darknet | 78.5% | 47.2% | 77.1% | 44.1% | 85.7% | 59.8% | 72.6% | 37.8% |
| YOLOv5-m | New CSP-Darknet | 80.4% | 51.3% | 81.3% | 50.5% | 86.3% | 62.3% | 73.8% | 41.2% |
| YOLOv5-l | New CSP-Darknet | 80.6% | 52.6% | 81.5% | 52.1% | 87.0% | 64.1% | 73.2% | 41.7% |
| YOLOv5-x | New CSP-Darknet | 81.4% | 53.0% | 82.0% | 52.8% | 88.6% | 64.1% | 73.6% | 41.9% |
| YOLOv6-n | EfficientRep | 76.3% | 47.9% | 80.6% | 49.2% | 88.8% | 60.9% | 59.5% | 33.6% |
| YOLOv6-s | EfficientRep | 79.0% | 48.2% | 80.0% | 48.4% | 86.0% | 59.1% | 70.9% | 37.1% |
| YOLOv6-m | CSPBep | 80.4% | 54.1% | 83.4% | 54.1% | 90.1% | 64.7% | 67.8% | 43.6% |
| YOLOv6-l | CSPBep | 82.9% | 55.9% | 85.7% | 55.8% | 91.7% | 67.5% | 71.4% | 44.3% |
| YOLOv7-t | E-ELAN | 71.1% | 39.7% | 67.4% | 36.0% | 79.8% | 49.8% | 66.1% | 33.2% |
| YOLOv7 | E-ELAN | 77.5% | 47.8% | 77.4% | 45.9% | 82.5% | 57.2% | 72.7% | 40.2% |
| YOLOv7-x | E-ELAN | 79.7% | 53% | 81.9% | 52.8% | 85.7% | 64.1% | 71.5% | 41.9% |
| YOLOX-n | CSP-DarkNet | 73.0% | 39.5% | 71.3% | 37.3% | 80.7% | 48.2% | 67.1% | 32.9% |
| YOLOX-t | CSP-DarkNet | 77.7% | 49.2% | 75.9% | 48.0% | 85.7% | 60.2% | 71.5% | 39.5% |
| YOLOX-s | CSP-DarkNet | 77.8% | 50.2% | 76.0% | 48.5% | 85.7% | 60.7% | 71.6% | 41.3% |
| YOLOX-m | CSP-DarkNet | 78.2% | 52.2% | 76.4% | 51.4% | 86.3% | 62.2% | 72.0% | 43.0% |
| YOLOX-l | CSP-DarkNet | 78.5% | 52.6% | 76.8% | 52.1% | 86.4% | 62.6% | 72.3% | 43.2% |
| YOLOX-x | CSP-DarkNet | 78.8% | 53.4% | 77.1% | 52.2% | 86.9% | 64.1% | 72.5% | 43.9% |
| PP-YOLO | ResNet50-vd-dcn | 76.4% | 45.1% | 75.7% | 42.6% | 84.3% | 56.3% | 69.2% | 36.5% |
| PP-YOLOv2 | ResNet50-vd-dcn | 77.3% | 47.1% | 77.8% | 44.8% | 84.6% | 58.1% | 69.5% | 38.2% |
| PP-YOLOE-s | CSPRepResNet | 64.6% | 38.9% | 64.6% | 36.4% | 78.6% | 50.1% | 50.5% | 27.5% |
| PP-YOLOE-m | CSPRepResNet | 74.2% | 44.8% | 73.9% | 43.4% | 84.5% | 56.7% | 64.3% | 34.4% |
| PP-YOLOE-l | CSPRepResNet | 75.4% | 46.4% | 76.7% | 46.0% | 85.6% | 57.9% | 63.8% | 35.4% |
| PP-YOLOE+-s | CSPRepResNet | 70.6% | 44.0% | 68.1% | 40.4% | 82.6% | 56.1% | 61.0% | 35.6% |
| PP-YOLOE+-m | CSPRepResNet | 78.8% | 50.9% | 79.2% | 49.3% | 85.2% | 60.4% | 72.1% | 42.9% |
| PP-YOLOE+-l | CSPRepResNet | 78.9% | 51.0% | 79.1% | 49.9% | 85.8% | 61.7% | 71.9% | 41.4% |
| Faster R-CNN | MobileNetV2 | 45.6% | 19.4% | 38.5% | 15.8% | 60.6% | 26.3% | 30.5% | 12.6% |
| Faster R-CNN | ResNet50 | 71.5% | 43.3% | 72.5% | 42.3% | 83.9% | 54.2% | 54.2% | 29.3% |

1. The best results in each evaluation metric column are in bold and the second best results are underlined.
2. ↑(↓) indicates that larger (smaller) values lead to better (worse) performance. [symbol]
indicates data missing or illegible when filed

Table 1 showed that YOLOv6-1 has the best performance among all the models in terms of the accuracy, whose

$$m A {P}_{0.5}^{test}$$

is 82.9% and

$$m A {P}_{0.5 : 0.95}^{test}$$

is 55.9%, while the worst one is PPYOLOE-s, whose results on

$$m A {P}_{0.5}^{test} and {mAP}_{0.5 : 0.95}^{test}$$

are 64.6% and 38.9%, respectively. The two models are single-stage object detection networks. For Faster R-CNN which is the most representative two-stage object detection network, the original backbone network VGG16 was abandoned and changed it to a more lightweight but stronger backbone, MobileNetV2 and a classic backbone, ResNet50. However, when the backbone is MobileNetV2,

$$m A {P}_{0.5}^{test} and {mAP}_{0.5 : 0.95}^{test}$$

are 45.6% and 19.4%, respectively, lower compared to the results of the one-stage network in Table 1. When the backbone is ResNet50, compared with MobileNetV2, the detection capability has been greatly improved,

$$m A {P}_{0.5}^{test} and {mAP}_{0.5 : 0.95}^{test}$$

are 71.5% and 43.3% respectively. However, they are still lower than most one-stage detection models, indicating that using one-stage detection models generally has the best performance.

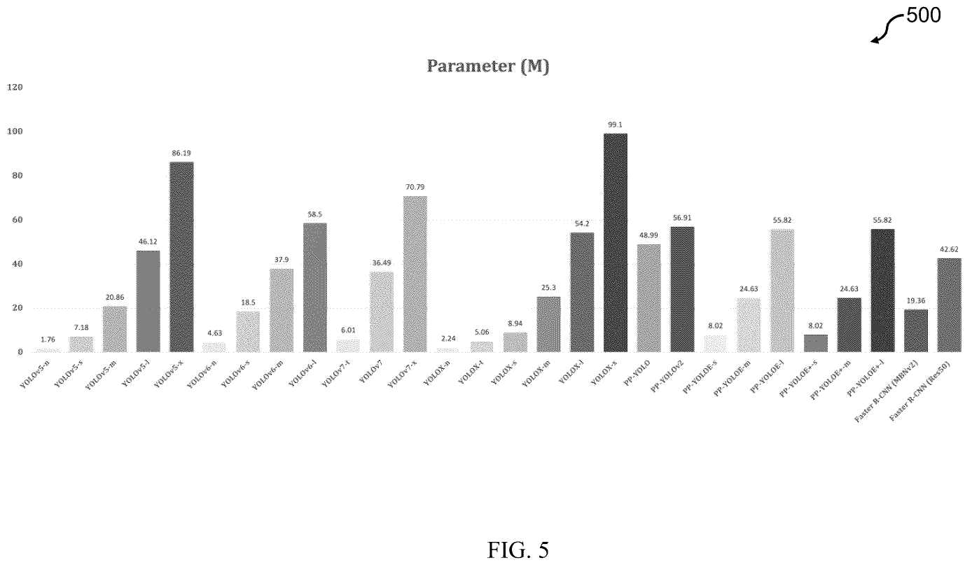

Now referring to FIG. 5, the example histogram 500 showed the number of parameters of these selected state-of-the-art real-time object detection networks for a complexity comparison. As shown in 500, YOLO5-n takes the smallest parameters while the YOLOX-x takes the largest. Based on this analysis, YOLOv6-1 is selected as the AI model 121 to do real-world experiments.

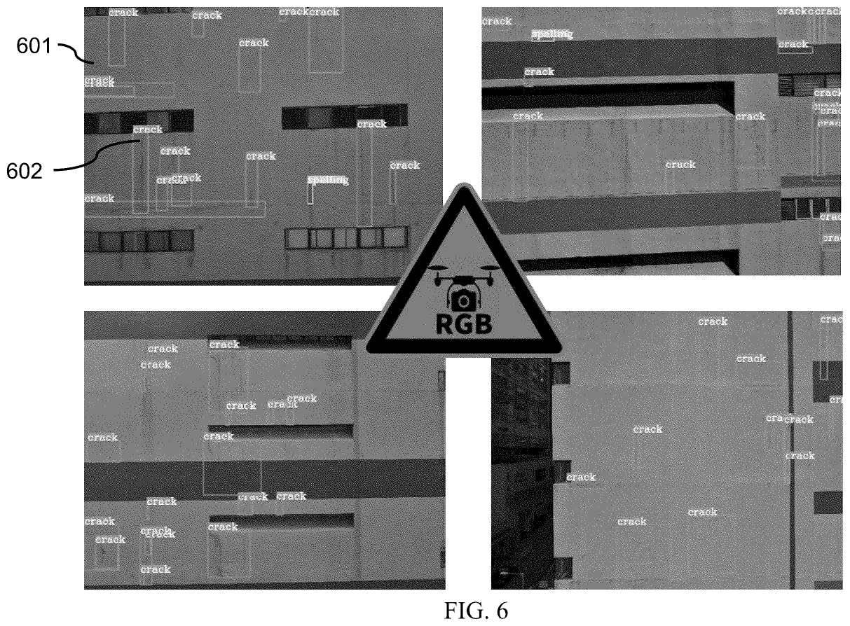

FIG. 6 showed the detection results of a real-world building, which include identified defect images or detected images such as 601, identified defect segments in defect bounding boxes such as 602 and indicated as “crack”, and icon for UAV captured RGB image 603.

Still referring to FIG. 4, the training submodule 122 is configured to execute example workflow 400 for model training and/or deployment. In this example, the defect identification (such as detection) process using the AI model (e.g., YOLOv6 model) follows the steps below.

Step 402—Initial image input: The AI model is configured to receive an image, which is captured from various sources such as cameras, drones, or smartphones.

Step 404—Process image using backbone network: The received image is then passed through the backbone network, such as CSPDarknet53 in YOLOv6. The backbone extracts key features from the image that are critical for defect detection.

Step 406—Process backbone features through prediction heads: The extracted features are processed further by the prediction heads. These heads predict the class (e.g., crack, peeling) and location (bounding box coordinates) of the defects present in the image.

Step 408—Compute joint loss: Once predictions are made, the joint loss function is computed, which includes both the classification loss (the accuracy of predicted defect types) and the localization loss (how accurately the predicted bounding boxes match the ground truth).

Step 410—Receive ground truth for image: Ground truth data, which includes the actual defect locations and classes, is provided, for example, from annotated training images. This serves as a reference to compare the predictions made by the model.

Step 412—Check performance: The model's performance is evaluated using a predetermined model performance condition, a criteria like mAP (mean Average Precision). If the model's accuracy meets the required threshold, it can proceed to deploy. Otherwise, further adjustments are made to improve performance.

Step 414—Adjust network weights with back propagation: If the model's predictions do not meet the required accuracy, backpropagation is used to adjust the network weights. This process helps the model learn from its errors and improves the detection performance.

Repeat above steps in 400 until the predetermined model performance condition is satisfied: These steps are repeated iteratively until the model's performance meets the predefined accuracy thresholds.

Step 416—Deploy: Once the model achieves the desired results, it is ready for real-world deployment for defect identification (such as detection).

### 1.4 Digital Twin Module

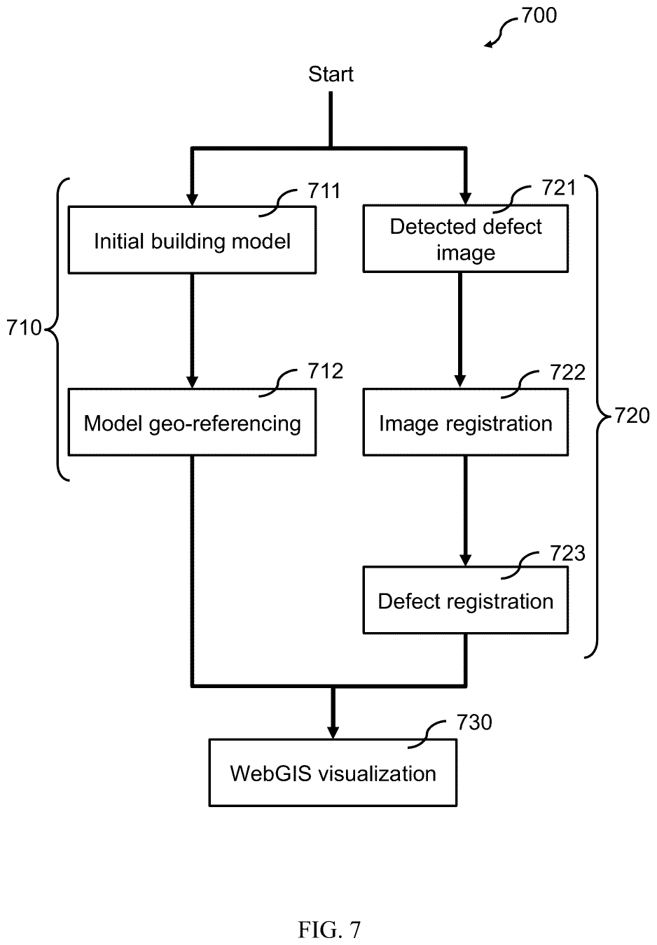

Now referring to FIG. 7 with reference to FIG. 1, showing an example workflow 700 of steps executed by the Digital Twin Module 130. In this example, the digital twin module 130 generally includes a geo-reference submodule 131, a registration submodule 132 and a visualization submodule 133, which are connected with each other. The geo-reference submodule 131 is configured to geo-reference a 3D model 1311 of the building to obtain a geo-referenced 3D model 1312 by executing steps 710. The registration submodule 132 is configured to register the at least one identified defect image 1021 and the at least one identified defect segment 102 to the geo-referenced 3D model 1321 to obtain at least one registered defect image 103 and at least one registered defect segment 104 by executing steps 720. The visualization submodule 133 is configured to visualize the at least one registered defect image 104, at least one the registered defect segment 103 and the geo-referenced 3D model 1312 by executing step 730 such that the defect of the façade of the building is automatedly inspected through the at least one visualized registered defect segment, the at least one visualized registered defect image, and the visualized geo-referenced 3D model.

With steps 710, the geo-reference submodule is configured to execute the following steps. Step 711: obtaining, by the geo-reference submodule, a 3D model of the building or the initial building model. Step 712: geo-referencing, by the geo-reference submodule, the 3D model to a geographical coordinate system.

With steps 720, the registration submodule is configured to execute the following steps. Step 721: receiving, by the registration submodule, the identified (or detected) defect image including the identified defect segments. Step 722: registering, by the registration submodule, the identified defect image to the geo-referenced 3D model to obtain registered defect image. Step 723: registering, by the registration submodule, the identified defect segment to the geo-referenced 3D model to obtain registered.defect segment.

With step 730, the visualization submodule is a WebGIS platform, which is configured to receive the constructed multidimensional building defect model by the fusion of the building geometric model (geo-referenced 3D model) from the geo-reference submodule configured to execute steps 710 and the defect information (registered defect image and registered defect segment) from the registration submodule configured to execute steps 720 for result visualization and interaction for further maintenance actions.

In one embodiment, the digital twin module 130 is configured to use a GIS-registering method to index these defects with different classes information by geographic information, which improves the efficiency of maintenance practitioners. The data required includes the AI detection result (identified defect image and identified defect segment), the geographic information (such as geographic coordinates), and the building footprint (such as a 3D model). In one example, the registration submodule is configured to explore the depth of the defects on the image to locate the individual defect on the wall, which makes it possible to visualize it on the model for maintenance.

### 1.4.1 Geo-Reference Submodule

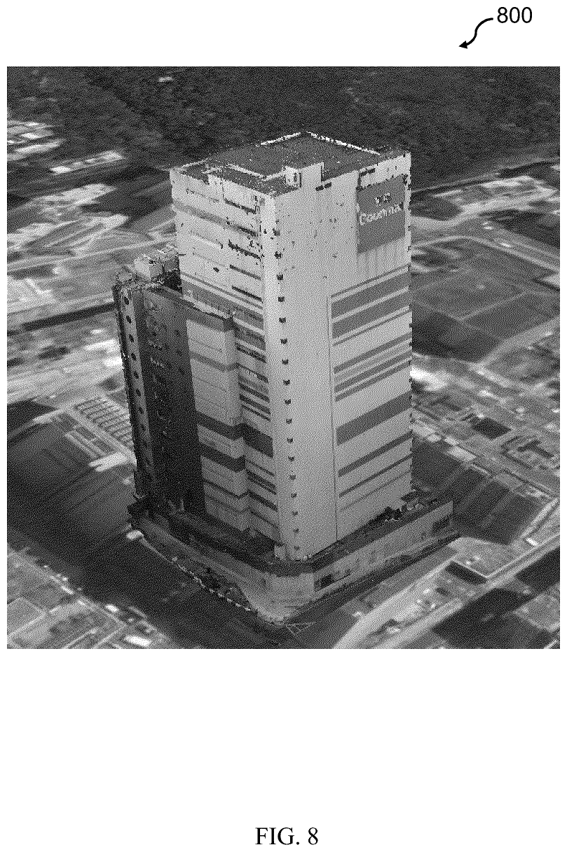

Still referring to FIG. 7 with reference to FIG. 1, showing an example workflow 700 of steps executed by the digital Twin Module 130. In this example, the geo-reference submodule is configured to geo-reference a 3D model of the building to obtain a geo-referenced 3D model. The steps 710 executed by the registration submodule are configured to align the 3D model to the corresponding geographic location. The coordinate is selected as the WGS84 system, which is commonly used in web service. In some embodiments of this workflow 700, any format of 3D model contained the geometry information is acceptable, including the 3D mesh model or CAD model. In this example, the 3D model used is the 3D reconstructed model or BIM model from the collected data, which is lacking the geographic information and needs to be aligned to the reference world. Now referring to FIG. 8, showing an example of a geo-referenced 3D model 800 in geographic reference map.

### 1.4.2 Registration Submodule

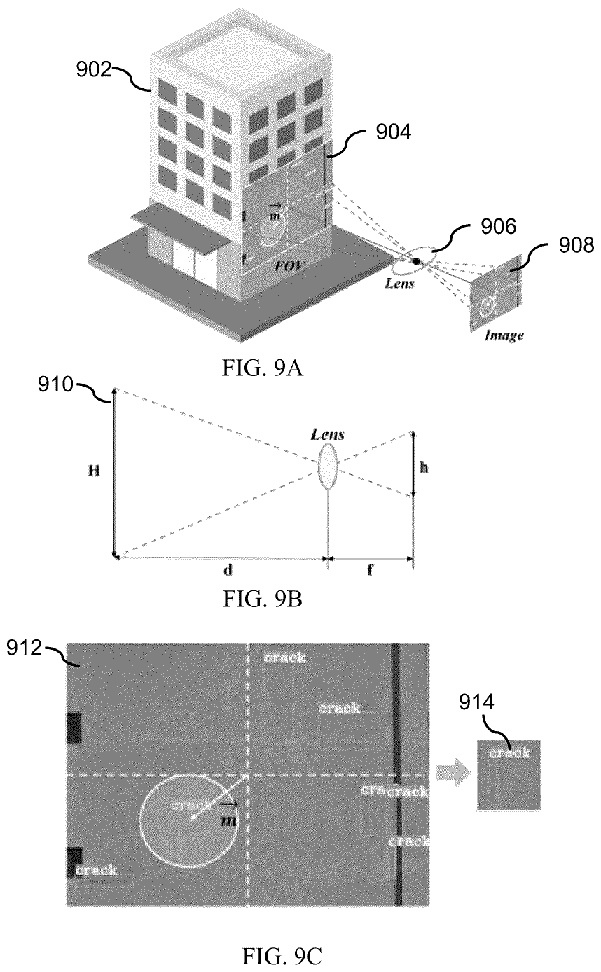

Now referring to the FIGS. 9A, 9B, and 9C with reference to FIGS. 2A and 2B, showing an example of the two-level registration method (image-level and defect-level) executed by the registration submodule. In this example, the registration submodule is configured to register the at least one identified defect image 912 and the at least one identified defect segment 914 to the geo-referenced 3D model 902 to obtain at least one registered defect image and at least one registered defect segment. UAV 210 is configured to capture defect images by positioning the camera perpendicularly to the building wall. The camera lens 906 of the imaging device (such as a UAV mounted high-resolution camera), representing the camera position, captures an image 908 that corresponds to the Field of View or FOV 904 on the wall surface of the geo-referenced 3D model 902 of the building. To accurately analyze the defects, the pixel plane of the captured image 908 needs to be mapped onto the wall plane of the geo-referenced 3D model 902 of the building. Image-level registration establishes a mapping between the captured image 908 and the FOV 904, while defect-level registration further correlates identified defect segments 914 in the identified defect image 912 to their corresponding global geographic locations on the building 902. Additionally, the vertical FOV 910 defines the vertical projection, while defect identification (such as detection) in the defect image 912 and the corresponding defect segment 914 are processed.

In this example, the registration submodule is configured to execute the image-level registration by calculating the projection point of the camera on the wall surface using geometric methods. The process is as follows.

Input Data: This includes the geographic coordinates of the camera point (Iₜ(lonₜ, latₜ, altₜ)), the distance to the wall d, and the angle θ between the wall's normal vector \vec{n} and the latitude.

Geographic Mapping: On WGS84, the length of a degree of latitude at latitude Φ can be calculated by:

$$111132.92 - 559.82 cos 2 φ + 1. 175 cos 4 φ - 0. 0023 cos 6 φ$$

Then the length of longitude can be calculated by:

$$111412.84 cos φ - 93 \text{.5} cos 3 φ + 0. 118 cos 5 φ$$

Using these, the projection point I*ₜ is determined by combining the geographic data and the wall's normal vector.

Output Result: The projection point

$$( {I}_{t}^{*} ( l o {n}_{t}^{*} , {lat}_{t}^{*} , {alt}_{t}^{*} ) )$$

represents the image's corresponding location on the wall, enabling further defect analysis.

By applying the normal vector of the wall, the identified defect image was registered on geo-referenced 3D model, as the Algorithm 1 shown in Table 2.

TABLE 2
Pseudocodes of image-level registration.
Algorithm 1: Image-level defect registration

```
      Input: Geographical coordinates of image:
                  Iₜ (lon [symbol]  , lat [symbol]  ,alt [symbol]  ), Distance to the wall: d;
                  Angle between the wall's normal vector \vec{n}
                  and the latitude: θ.
      Output: Projection point of lₜ:
                    ${I}^{*} \text{?} ( lon \text{?} , lat \text{?} , alt \text{?} )$
  1 Initialize t array of the detected images;
  2 while t ∈ 1, 2, . . . , tₘₐₓ do
  3 | The unit length of latitude and longitude;
  4 | u [symbol]   = 111132.92 − 559.82 cos 2 (lat [symbol]  ) +
      | 1.175 cos (4lat [symbol]  ) − 0.0023 cos (6lat [symbol]  )
  5 | u [symbol]  = 111412.84 cos lat [symbol]   −
      | 93.5 cos(3lat [symbol]  ) + 0.118 cos (5lat [symbol]  )
  6 | The projection vector:
$7 \vert {n}^{\text{?}} = ( - \frac{sin ( \text{?} )}{\text{?}} , - \frac{cos ( \text{?} )}{\text{?}} , 0 )$
  8 | The projection point:
  $9 \vert {I}^{*} \text{?} = I \text{?} + d * {n}^{\text{?}}$
10 └ l ← t + 1
11 Output the projection point I* (lon [symbol]  , lat [symbol]  , alt [symbol]  ) [symbol]
indicates data missing or illegible when filed
```

In this example, the registration submodule is configured to realize the individual defect management, which is required to locate each identified defect segment 914. The method is to combine the relative location of the defect on the defect image 912 and calculate the normal vector \vec{m} as shown in FIG. 9C. The calculation of \vec{m} is shown in Algorithm 2 in Table 3 as follows.

TABLE 3
Pseudocodes of defect-level registration.
Algorithm 2: Defect-level defect registration

```
        Input: Geographical coordinates of projection
                    $point \text{?} ( lon \text{?} , lat \text{?} , alt \text{?} ) .$
        $Output : Detects location of I \text{?}$
                      $DI \text{?} ( lon \text{?} , lat \text{?} , alt \text{?} ) , i ∈ 1 , 2 , … , \text{?} .$
      1 Initialize the t array for the detected images, and the
          i array for the detected defects;
      2 while t ∈ 1, 2, . . . , tₘₐₓ do
      3 | for i ∈ 1, 2, . . . , iₘₐₓ do
      4 | | The FOV of the image:
      $5 \vert \vert W = \frac{\text{?} \times d}{f}$
      $6 \vert \vert H = \frac{\text{?} \times d}{f}$
      7| | The offset on the image:
      8| | of̅ fₗ = (W * (ω [symbol]   - 0.5), H * (h [symbol]   - 0.5))
      9| | The physical offset vector:
    $\vert \vert {m}^{\text{?}} = \text{?} \times ( \frac{cos ( \text{?} )}{\text{?}} , \frac{sin ( \text{?} )}{\text{?}} , 0 )$
    10| | The location of the defect:
$11 \vert \vert DI \text{?} = I \text{?} + \text{?}$
12| | The duplication factor:
    | | T = \sqrt{(0.1/unit_{long})² + (0.1/unitₗₐₜ)²}
$13 \vert \vert for DI \text{?} : \text{?} ← 1 to \text{?} - 1 , i ← 1 to i - 1 do$
$14 \vert \vert if \sqrt{DI \text{?} + DI \text{?}} > T then$
$15 \vert ⌊ ⌊ Update the new defect DI \text{?}$
  16| └ l ← i + 1
  17└ t ← t + 1
  18 Output the registered defects
          DI*(lon [symbol]  ,lat [symbol]  ,alt [symbol]  ). [symbol]
indicates data missing or illegible when filed
```

In this example, the registration submodule is configured to execute the defect-level registration that refines the mapping process by determining the precise location of individual defect segments in the geographic space. The process is as follows.

FOV and Offset: The field of view is calculated using the camera's parameters:
Horizontal width:

$$W = \frac{w \cdot d}{f}$$

Vertical height:

$$H = \frac{h \cdot d}{f}$$

where w and h are the image dimensions (in pixels), d is the distance to the wall, and f is the focal length of the camera.

Defect Localization: The offset of each defect such as 914 on the image 912

$$( σ \vec{f {f}_{1}} )$$

is determined relative to the image center. The defect's geographic location

$$( {DI}_{t i}^{*} )$$

is then calculated as:

$$D {I}_{t i}^{*} = {I}_{t}^{*} + \vec{m}$$

where (\vec{m}) is the physical offset vector.

Redundancy Elimination: A tolerance threshold is defined as:

$$D = \sqrt{{( \frac{0.1}{{unit}_{l o n g}} )}^{2} + {( \frac{0.1}{{unit}_{lat}} )}^{2}}$$

Defects with distances below this threshold (about 20 cm in size) are considered duplicates and filtered out.

Output Result: The final defect locations

$$( D {1}^{*} ( lo {n}_{I}^{*} , {lat}_{I}^{*} , {alt}_{I}^{*} ) )$$

provide precise semantic and geographic data for defect management.

In some embodiments, this two-level registration process integrates geometric and semantic mapping, enabling precise and efficient documentation of structural defects. Image-level registration provides an overview of surface conditions, while defect-level registration offers detailed data for targeted maintenance and long-term monitoring. For the image level registration, it provides visual conditions of surface area, which can help the engineers to evaluate the structure damage level. For the defect level registration, it provides semantic information like defect classification and location for all individual defects without overlap, which contributes to document the building defects.

### 1.4.3 Visualization Submodule

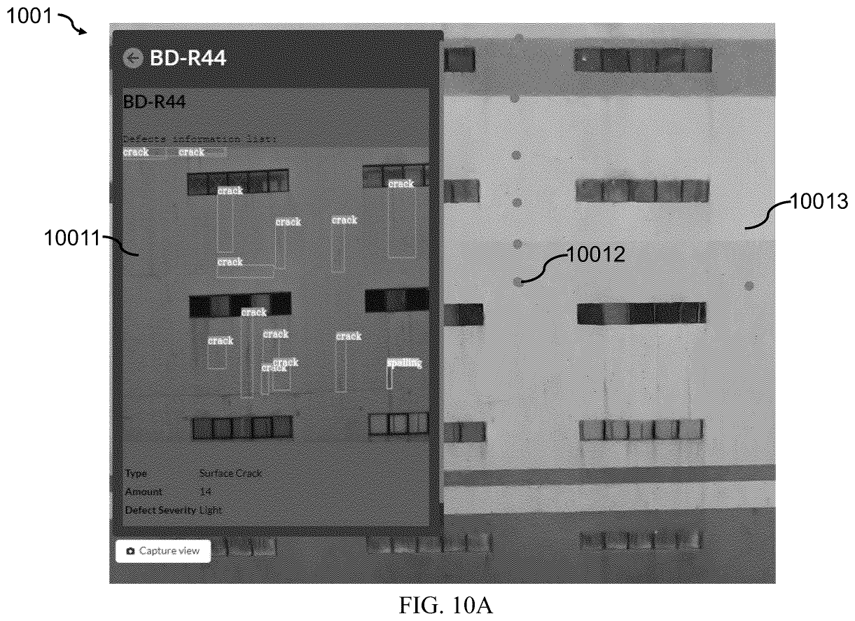

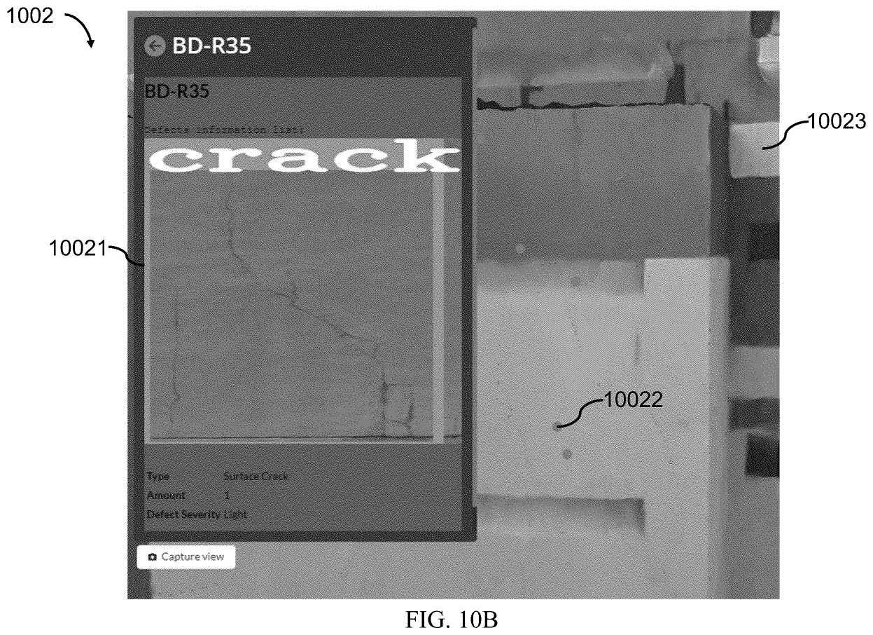

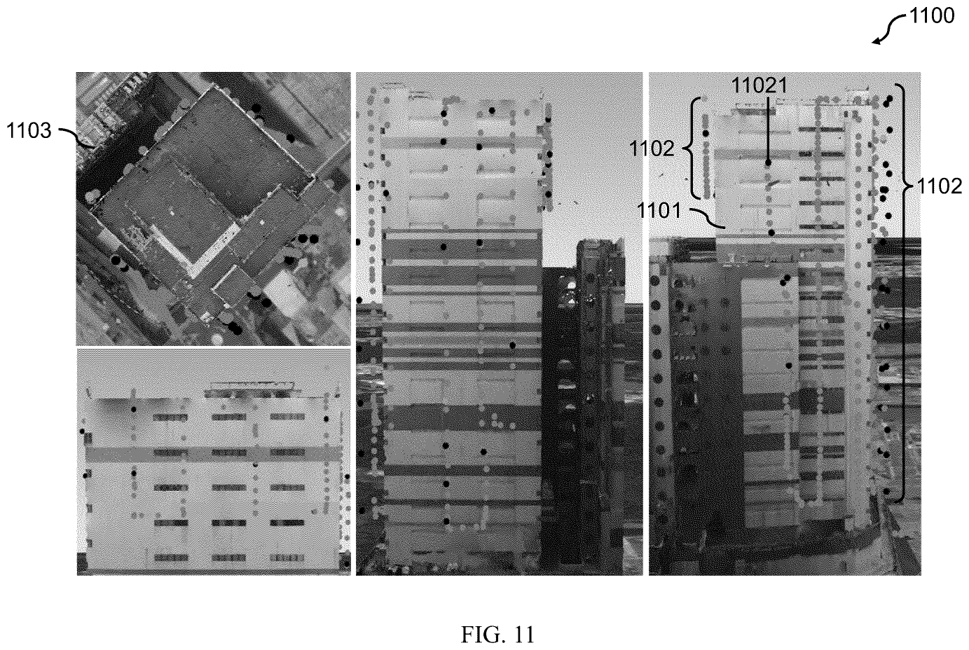

Now referring to FIGS. 10A, 10B, and 11 with reference to FIG. 7, showing examples of the visualization results of the visualization submodule. In this example, the visualization submodule is configured to visualize the at least one registered defect image, at least one the registered defect segment and the geo-referenced 3D model such that the defect of the façade of the building is automatedly inspected through the at least one visualized registered defect segment, the at least one visualized registered defect image, and the visualized geo-referenced 3D model.

In this example, the visualization submodule is a WebGIS platform, which includes a cloud-based user interface (UI) deployed on the web. The WebGIS platform is configured to receive the constructed multidimensional building defect model by the fusion of the building geometric model (geo-referenced 3D model) from the geo-reference submodule configured to execute steps 710 and the defect information (registered defect image and registered defect segment) from the registration submodule configured to execute steps 720 for result visualization and interaction for further maintenance actions.

FIG. 11 illustrated an example overall visualization result 1100 of the visualization submodule integratedly visualizing registered defect image, registered defect segment and geo-referenced 3D model of the building. In this example, the user interface of the WebGIS platform is configured to visualize the geo-referenced 3D model 1101 with the defect labels 1102, the base map 1103 is the satellite map for geo-referencing. Users can get access to the detailed information by clicking on the label as shown in FIGS. 10A and 10B to obtain the defect image, defect classification and the severity level. In some embodiments, the defect labels 1102 can be defect labels in different colors 11021 for showing different kinds of defects.

In one embodiment, as shown in FIG. 10A, the content host 1001 for users includes the building's reconstruction model or BIM model 10013 (partial variation of the geo-referenced 3D model), and the defect's 2D information 10012. When clicked, the identified defect image and the corresponding identified defect segments with defect information (such as type, amount, defect severity) can be shown in a detailed view 10011.

In another embodiment, as shown in FIG. 10B, the content host 1002 for users includes the geo-referenced 3D model 10023 and the defect's 3D information 10022. When clicked, the identified defect image and the corresponding identified defect segments with defect information (such as type, amount, defect severity) can be shown in a detailed view 10021.

### Example 2—Methods

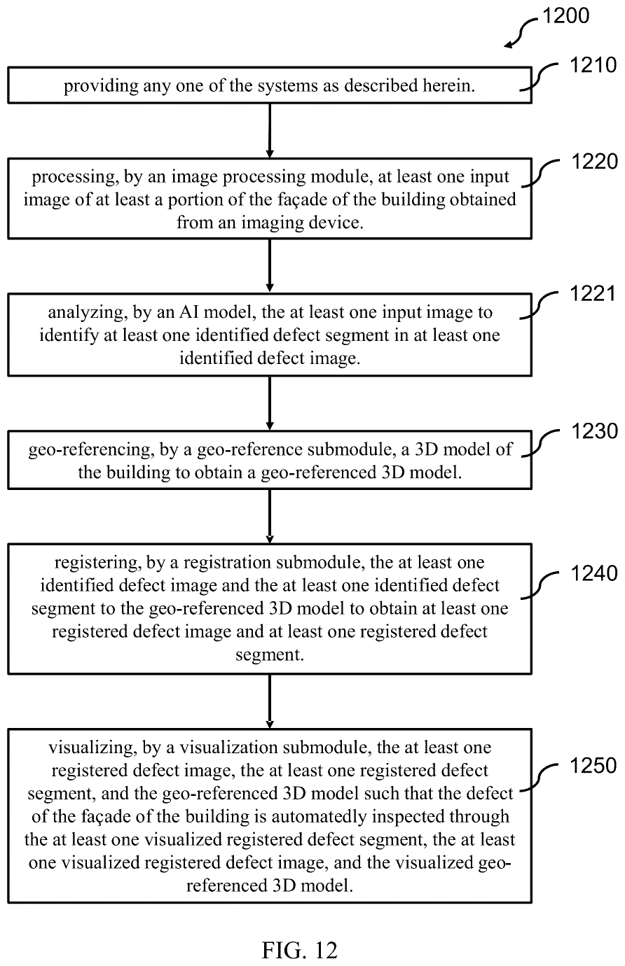

Now referring to FIG. 12, showing an example method 1200 for automated inspection of a defect of a façade of a building, including the steps of:

Step 1210: providing any one of the systems as described herein.

Step 1220: processing, by an image processing module, at least one input image of at least a portion of the façade of the building obtained from an imaging device.

Step 1221: analyzing, by an AI model, the at least one input image to identify at least one identified defect segment in at least one identified defect image.

Step 1230: geo-referencing, by a geo-reference submodule, a 3D model of the building to obtain a geo-referenced 3D model.

Step 1240: registering, by a registration submodule, the at least one identified defect image and the at least one identified defect segment to the geo-referenced 3D model to obtain at least one registered defect image and at least one registered defect segment.

Step 1250: visualizing, by a visualization submodule, the at least one registered defect image, the at least one registered defect segment, and the geo-referenced 3D model such that the defect of the façade of the building is automatedly inspected through the at least one visualized registered defect segment, the at least one visualized registered defect image, and the visualized geo-referenced 3D model.

In some examples, the method 1200 further includes the steps of:
obtaining, by the image acquisition module, at least one training image of at least a portion of the façade of the building.
training, by the training submodule, the AI model based on the at least one training image.

In some examples, the method 1200 further includes the steps of:
operating, by the image acquisition module, the at least one unmanned equipment to obtain the at least one training image along a pre-determined path such that the at least one training image covering at least a portion of the façade of the building is obtained.

In some examples, the method 1200 further includes the steps of:
operating, by the image acquisition module, the at least one UAV mounted with an unmanned-vehicle-mounted camera to obtain the at least one training image along a pre-determined flight path such that the at least one training image covering at least a portion of the façade of the building is obtained.

In some examples, the method 1200 further includes the steps of:
sequentially annotating, by the first-round annotation component, the second-round annotation component and the third-round annotation component, the at least one training image based on the defect to obtain an at least one annotated training image;
determining, by the annotation validation component, whether the at least one annotated training image satisfies a predetermined annotation performance condition,
if yes, proceeding with the step of outputting, by the annotation validation component, the at least one annotated training image.
if not, activating, by the annotation validation component, the annotation revision component and the third-round annotation component.
re-annotating, by the third-round annotation component, the at least one training image;
repeating above steps until the at least one annotated training image satisfies the predetermined annotation performance condition.
outputting, by the annotation validation component, the at least one annotated training image.

In some examples, the method 1200 further includes the steps of:
individual-annotating, by the first-round annotation component, the at least one training image to obtain at least one first-round annotated training image.
cross-verifying, by the second-round annotation component, the at least one first-round annotated training image to obtain at least one second-round annotated training image.
expert-reviewing, by the third-round annotation component, the at least one second-round annotated training image to obtain the at least one annotated training image.

In some examples, the method 1200 further includes the steps of:
training, by the model training component, the AI model based on the at least one annotated training image;
determining, by the model validation component, whether the AI model stratifies a predetermined model performance condition,
if yes, proceeding with step of deploying, by the model validation component, the AI model.
if not, activating, by the model validation component, the backpropagation component.
adjusting, by the backpropagation component, the AI model;
re-training, by the model training component, the AI model;
repeating above steps until the AI model stratifies the predetermined model performance condition.
deploying, by the model validation component, the AI model.

In some examples, provided is a non-transitory computer-readable medium storing at least one computer program for implementing any of the methods as described herein.

The above embodiments are described by way of example only. Many variations are possible without departing from the scope of the invention as defined in the appended claims.

For clarity of explanation, in some examples, the present technology has been presented as including individual functional blocks including functional blocks comprising devices, device components, steps or routines in a method embodied in software, or combinations of hardware and software.

Methods according to the above-described examples can be implemented using computer-executable instructions that are stored or otherwise available from computer readable media. Such instructions can comprise, for example, instructions and data which cause or otherwise configure a general-purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, Universal Serial Bus (USB) devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

It is to be understood that any feature described in relation to any one example may be used alone, or in combination with other features described, and may also be used in combination with any features of any other of the examples, or any combination of any other of the examples.

Blocks, steps, and/or methods discussed herein can be executed and/or made by a user, a user agent (including machine learning agents and intelligent user agents), a software application, an electronic device, a computer, firmware, hardware, a process, a computer system, and/or an intelligent personal assistant. Furthermore, blocks, steps, and/or methods discussed herein can be executed automatically with or without instruction from a user.

It should be understood for those skilled in the art that the division between hardware and software is a conceptual division for ease of understanding and is somewhat arbitrary. Moreover, it will be appreciated that peripheral devices in one computer installation may be integrated to the host computer in another. Furthermore, the application software systems may be executed in a distributed computing environment. The software program instructions and its related datasets can be stored in a separate file server or database server and/or is transferred to the local host for execution. For example, the parameters of the predetermined flight path as shown in FIGS. 2A and 2B, the parameters of the image annotation/labelling process, the parameters of Algorithms 1 and 2 (Table 2 and 3) in Example 1 are therefore exemplary embodiments of how the present invention can be implemented. Those skilled in the art will appreciate that alternative embodiments can be adopted to implement the present invention.

The exemplary embodiments of the present invention are thus fully described. Although the description referred to particular embodiments, it will be clear to one skilled in the art that the present invention may be practiced with variation of these specific details. Hence this invention should not be construed as limited to the embodiments set forth herein.

For example, an application of the current method is described above as automated defect inspection of a façade of a building but in other example embodiments may be applied, e.g. building/construction related applications integrated in a smart city, disaster response, utility system inspections, etc.

Methods discussed within different figures can be added to or exchanged with methods in other figures. Further, specific numerical data values (such as specific quantities, numbers, categories, etc.) or other specific information should be interpreted as illustrative for discussing example embodiments. Such specific information is not provided to limit example embodiment.

1. A system for automated inspection of a defect of a façade of a building, comprising:
an image processing module that processes at least one input image of at least a portion of the façade of the building obtained from an imaging device,
wherein the image processing module comprises an AI model that is configured to analyze the at least one input image to identify at least one identified defect segment in at least one identified defect image; and
a digital twin module that comprises a geo-reference submodule; a registration submodule; and a visualization submodule, which are connected with each other,
wherein the geo-reference submodule is configured to geo-reference a 3D model of the building to obtain a geo-referenced 3D model,
wherein the registration submodule is configured to register the at least one identified defect image and the at least one identified defect segment to the geo-referenced 3D model to obtain at least one registered defect image and at least one registered defect segment,
and wherein the visualization submodule is configured to visualize the at least one registered defect image, at least one the registered defect segment and the geo-referenced 3D model such that the defect of the façade of the building is automatedly inspected through the at least one visualized registered defect segment, the at least one visualized registered defect image, and the visualized geo-referenced 3D model.

2. The system of claim 1, further comprising:
an image acquisition module that is configured to be executed by at least one unmanned equipment to obtain at least one training image of at least a portion of the façade of the building, and
wherein the image processing module further comprises a training submodule that is configured to train the AI model based on the at least one training image.

3. The system of claim 2, wherein the image acquisition module is configured to operate the at least one unmanned equipment to obtain the at least one training image along a pre-determined path such that the at least one training image covering at least a portion of the façade of the building is obtained.

4. The system of claim 3, wherein the at least one unmanned equipment is at least one unmanned aerial vehicle (UAV), wherein the at least one UAV is configured to be mounted with an unmanned-vehicle-mounted camera, and wherein the pre-determined path is a pre-determined flight path.

5. The system of claim 1, wherein the AI model comprises a YOLOv6 model.

6. The system of claim 1, wherein the imaging device comprises a camera, a smartphone, and/or an unmanned-vehicle-mounted camera.

7. The system of claim 2, wherein the training submodule further comprises:
a first-round annotation component;
a second-round annotation component;
a third-round annotation component;
an annotation validation component; and
an annotation revision component,
wherein the first-round annotation component, the second-round annotation component, the third-round annotation component are configured to sequentially annotate the at least one training image based on the defect to obtain an at least one annotated training image, and
wherein the annotation validation component is configured to determine whether the at least one annotated training image satisfies a predetermined annotation performance condition,
if yes, the annotation validation component is configured to output the at least one annotated training image,
otherwise, the annotation validation component is configured to iteratively activate the annotation revision component and the third-round annotation component to re-annotate the at least one training image until the at least one annotated training image satisfies the predetermined annotation performance condition.

8. The system of claim 7, wherein the first-round annotation component is configured to perform individual-annotation, wherein the second-round annotation component is configured to perform cross-verification, and wherein the third-round annotation component is configured to perform expert-review.

9. The system of claim 7, wherein the training submodule further comprises:
a model training component;
a model validation component; and
a backpropagation component,
wherein the model training component is configured to train the AI model based on the at least one annotated training image,
and wherein the model validation component is configured to determine whether the AI model stratifies a predetermined model performance condition,
if yes, the model validation component is configured to deploy the AI model,
otherwise, the model validation component is configured to iteratively activate the backpropagation component to adjust the AI model and activate the model training component to re-train the AI model until the AI model stratifies the predetermined model performance condition.

10. A method of automated inspection of a defect of a façade of a building using a system of claim 1, the method comprising the steps of:
(a) processing, by an image processing module, at least one input image of at least a portion of the façade of the building obtained from an imaging device;
wherein the step (a) further comprises the step of:
(a1) analyzing, by an AI model, the at least one input image to identify at least one identified defect segment in at least one identified defect image;
(b) geo-referencing, by a geo-reference submodule, a 3D model of the building to obtain a geo-referenced 3D model;
(c) registering, by a registration submodule, the at least one identified defect image and the at least one identified defect segment to the geo-referenced 3D model to obtain at least one registered defect image and at least one registered defect segment; and
(d) visualizing, by a visualization submodule, the at least one registered defect image, the at least one registered defect segment, and the geo-referenced 3D model such that the defect of the façade of the building is automatedly inspected through the at least one visualized registered defect segment, the at least one visualized registered defect image, and the visualized geo-referenced 3D model.

11. The method of claim 10,
wherein the system further comprises an image acquisition module configured to be executed by at least one unmanned equipment,
wherein the image processing module further comprises a training submodule,
and wherein the method further comprises the steps of:
(1) obtaining, by the image acquisition module, at least one training image of at least a portion of the façade of the building; and
(2) training, by the training submodule, the AI model based on the at least one training image.

12. The method of claim 11, wherein step (1) obtaining the at least one training image comprises the step of:
(1.1) operating, by the image acquisition module, the at least one unmanned equipment to obtain the at least one training image along a pre-determined path such that the at least one training image covering at least a portion of the façade of the building is obtained.

13. The method of claim 12, wherein the at least one unmanned equipment is at least one unmanned aerial vehicle (UAV), wherein the at least one UAV is configured to be mounted with an unmanned-vehicle-mounted camera, and wherein step (1.1) operating the at least one unmanned equipment comprises the step of:
(1.1.1) operating, by the image acquisition module, the at least one UAV mounted with an unmanned-vehicle-mounted camera to obtain the at least one training image along a pre-determined flight path such that the at least one training image covering at least a portion of the façade of the building is obtained.

14. The method of claim 10, wherein the AI model comprises a YOLOv6 model.

15. The method of claim 10, wherein the imaging device comprises camera, smartphone, and/or unmanned-vehicle-mounted camera.

16. The method of claim 11, wherein the training submodule comprises:
a first-round annotation component;
a second-round annotation component;
a third-round annotation component;
an annotation validation component; and
an annotation revision component,
and wherein the step (2) training the AI model comprises the steps of:
(2.1) sequentially annotating, by the first-round annotation component, the second-round annotation component and the third-round annotation component, the at least one training image based on the defect to obtain an at least one annotated training image;
(2.2) determining, by the annotation validation component, whether the at least one annotated training image satisfies a predetermined annotation performance condition,
if yes, proceeding with step (2.3);
if not, (2.2.1) activating, by the annotation validation component, the annotation revision component and the third-round annotation component;
(2.2.2) re-annotating, by the third-round annotation component, the at least one training image;
(2.2.3) repeating steps (2.2)-(2.2.3) until the at least one annotated training image satisfies the predetermined annotation performance condition; and
(2.3) outputting, by the annotation validation component, the at least one annotated training image.

17. The method of claim 16, wherein step (2.1) sequentially annotating the at least one training image comprises the steps of:
(2.1.1) individual-annotating, by the first-round annotation component, the at least one training image to obtain at least one first-round annotated training image;
(2.1.2) cross-verifying, by the second-round annotation component, the at least one first-round annotated training image to obtain at least one second-round annotated training image; and
(2.1.3) expert-reviewing, by the third-round annotation component, the at least one second-round annotated training image to obtain the at least one annotated training image.

18. The method of claim 16, wherein the training submodule further comprises:
a model training component;
a model validation component; and
a backpropagation component,
and wherein step (2) training the AI model further comprises the steps of:
(2.4) training, by the model training component, the AI model based on the at least one annotated training image;
(2.5) determining, by the model validation component, whether the AI model stratifies a predetermined model performance condition,
if yes, proceeding with step (2.6);
if not, (2.5.1) activating, by the model validation component, the backpropagation component;
(2.5.2) adjusting, by the backpropagation component, the AI model;
(2.5.3) re-training, by the model training component, the AI model;
(2.5.4) repeating steps (2.5)-(2.5.4) until the AI model stratifies the predetermined model performance condition; and
(2.6) deploying, by the model validation component, the AI model.

19. A non-transitory computer-readable medium storing at least one computer program for implementing a method of automated inspection of a defect of a façade of a building of claim 10, the computer-readable medium comprising:
(a) program instructions for processing, by an image processing module, at least one input image of at least a portion of the façade of the building obtained from an imaging device, wherein program instructions (a) further comprise:
(a1) program instructions for analyzing, by an AI model, the at least one input image to identify at least one identified defect segment in the at least one identified defect image;
(b) program instructions for geo-referencing, by a geo-reference submodule, a 3D model of the building to obtain a geo-referenced 3D model;
(c) program instructions for registering, by a registration submodule, the at least one identified defect image and the at least one identified defect segment to the geo-referenced 3D model to obtain at least one registered defect image and at least one registered defect segment; and
(d) program instructions for visualizing, by a visualization submodule, the at least one registered defect image, the at least one registered defect segment, and the geo-referenced 3D model such that the defect of the façade of the building is automatedly inspected through the at least one visualized registered defect segment, the at least one visualized registered defect image, and the visualized geo-referenced 3D model.

20. The computer-readable medium of claim 19,
wherein the system further comprises an image acquisition module configured to be executed by at least one unmanned equipment,
wherein the image processing module further comprises a training submodule,
and wherein the computer-readable medium further comprises:
(1) program instructions for obtaining, by the image acquisition module, at least one training image of at least a portion of the façade of the building;
(2) program instructions for training, by the training submodule, the AI model based on the at least one training image.

21. The computer-readable medium of claim 20, wherein program instructions (1) for obtaining the at least one training image comprise:
(1.1) program instructions for operating, by the image acquisition module, the at least one unmanned equipment to obtain the at least one training image along a pre-determined path such that the at least one training image covering at least a portion of the façade of the building is obtained.

22. The computer-readable medium of claim 21, wherein the at least one unmanned equipment is at least one unmanned aerial vehicle (UAV), wherein the at least one UAV is configured to be mounted with an unmanned-vehicle-mounted camera, and wherein program instructions (1.1) comprise:
(1.1.1) program instructions for operating, by the image acquisition module, the at least one UAV mounted with an unmanned-vehicle-mounted camera to obtain the at least one training image along a pre-determined flight path such that the at least one training image covering at least a portion of the façade of the building is obtained.

23. The computer-readable medium of claim 19, wherein the AI model comprises a YOLOv6 model.

24. The computer-readable medium of claim 19, wherein the imaging device comprises camera, smartphone, and/or unmanned-vehicle-mounted camera.

25. The computer-readable medium of claim 20, wherein the training submodule comprises:
a first-round annotation component;
a second-round annotation component;
a third-round annotation component;
an annotation validation component; and
an annotation revision component,
and wherein program instructions (2) for training the AI model comprise:
(2.1) program instructions for sequentially annotating, by the first-round annotation component, the second-round annotation component and the third-round annotation component, the at least one training image based on the defect to obtain an at least one annotated training image;
(2.2) program instructions for determining, by an annotation validation component, whether the at least one annotated training image satisfies a predetermined annotation performance condition,
if yes, proceeding with executing program instructions (2.3);
(2.2.1) program instructions for, if not, activating, by the annotation validation component, an annotation revision component and the third-round annotation component;
(2.2.2) program instructions for re-annotating, by the third-round annotation component, the at least one training image;
(2.2.3) program instructions for repeatedly executing program instructions (2.2)-(2.2.3) until the at least one annotated training image satisfies the predetermined annotation performance condition; and
(2.3) program instructions for outputting, by the annotation validation component, the at least one annotated training image.

26. The computer-readable medium of claim 25, wherein program instructions (2.1) for sequentially annotating the at least one training image comprise:
(2.1.1) program instructions for Individual-annotating, by the first-round annotation component, the at least one training image to obtain at least one first-round annotated training image;
(2.1.2) program instructions for cross-verifying, by the second-round annotation component, the at least one first-round annotated training image to obtain at least one second-round annotated training image; and
(2.1.3) program instructions for expert-reviewing, by the third-round annotation component, the at least one second-round annotated training image to obtain the at least one annotated training image.

27. The computer-readable medium of claim 25, wherein the training submodule further comprises:
a model training component;
a model validation component; and
a backpropagation component,
and wherein program instructions (2) for training the AI model further comprise:
(2.4) program instructions for training, by the model training component, the AI model based on the at least one annotated training image;
(2.5) program instructions for determining, by the model validation component, whether the AI model stratifies a predetermined model performance condition,
if yes, proceeding with executing program instructions (2.6);
(2.5.1) program instructions for, if not, activating, by the model validation component, the backpropagation component;
(2.5.2) program instructions for adjusting, by the backpropagation component, the AI model;
(2.5.3) program instructions for re-training, by the model training component, the AI model;
(2.5.4) program instructions for repeatedly executing program instructions (2.5)-(2.5.4) until the AI model stratifies the predetermined model performance condition; and
(2.6) program instructions for deploying, by the model validation component, the AI model.
